(19) United States
(12) Patent Application Publication
(10) Pub. No.: US 2010/0127996 A1
(43) Pub. Date: May 27, 2010

(54) In-vehicle device, remote control system, and remote control method

(75) Inventors: Toshio Kitahara, Kobe-shi (JP); Kazuhiro Okude, Kobe-shi (JP); Yoshiji Ishizuka, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/591,494

(22) Filed: Nov. 20, 2009

(30) Foreign Application Priority Data
Nov. 27, 2008 (JP) 2008-303165
Nov. 28, 2008 (JP) 2008-305256

(51) Int. Cl. G06F 3/041; G06F 3/01

(52) U.S. Cl. 345/173; 715/702

(57) ABSTRACT

To provide an in-vehicle device including a layout-information acquiring unit, a relating unit, a combination display unit, a converting unit, and an output-signal transmitting unit. The layout-information acquiring unit acquires layout information of input keys of the portable terminal device. The relating unit relates each input key included in the layout information to a predetermined area on a touch panel display. The combination display unit causes a layout screen of each input key related to a predetermined area on the touch panel display to be displayed in the touch panel display. The converting unit converts an input to the touch panel display into an output signal corresponding to a pressing operation of the input key or a combination of the output signals, based on the layout information. The output-signal transmitting unit transmits the output signal obtained by conversion to the portable terminal device.

### CROSS-REFERENCE TO RELATED APPLICATIONS

This application is based upon and claims the benefit of priority of the prior Japanese Patent Application No. 2008-303165, filed on Nov. 27, 2008; and Japanese Patent Application No. 2008-305256, filed on Nov. 28, 2008, the entire contents of both of which are incorporated herein by reference.

### BACKGROUND OF THE INVENTION

1. Field of the Invention

The present invention relates to an in-vehicle device, a remote control system, and a remote control method for remote-controlling a portable terminal device.

2. Description of the Related Art

Along with diffusion of car navigation systems using a global positioning system (GPS), many vehicles come to have in-vehicle devices with a navigation function incorporated therein. To respond to user's desire for multiple functions in in-vehicle devices, in-vehicle devices have become remarkably multifunctional.

For example, in many cases, in-vehicle devices include functions such as a television receiving function, a compact disc (CD) reproduction function, a digital versatile disk (DVD) reproduction function, in addition to a navigation function. However, multifunctional in-vehicle devices incur a high cost of the devices, and high price is not preferable for users.

Meanwhile, portable terminal devices such as mobile telephones have come to have a navigation function and a music reproduction function while maintaining lower price. Portable terminal devices having a short-distance wireless communication function such as Bluetooth® have also come into popular use. Therefore, there are approaches to use functions of a portable terminal device in an in-vehicle device, through mutual communications (linkage) between the portable terminal device and the in-vehicle device by connecting these devices by wireless communications using the short-distance wireless communication function. With this arrangement, it becomes possible to reduce the price of in-vehicle devices.

For example, Japanese Patent Application Laid-open No. 2003-244343 discloses a technique, according to which a display screen to be displayed on a screen of a portable terminal device and an operation screen having an input-key layout of the portable terminal device are transmitted to an in-vehicle device, and the display screen and the operation screen generated by the portable terminal device are together displayed in the display of the in-vehicle device.

However, in remote-controlling the portable terminal device by using the technique disclosed in Japanese Patent Application Laid-open No. 2003-244343, the display of the in-vehicle device always displays the operation screen having the input keys of the portable terminal device. Therefore, the display of the in-vehicle device cannot be effectively used.

For example, a display screen generated by an application program for navigation (hereinafter, “navi-application”) operated in the portable terminal device is not displayed in the entirety of the display of the in-vehicle device but is displayed in a display area other than an area occupied by the operation screen.

Therefore, even when the in-vehicle device having a larger display area than that of the portable terminal device is used, the display size of the display screen of a navi-application displayed on the in-vehicle device is not sufficiently large, and has a problem in visibility.

Further, when the technique disclosed in Japanese Patent Application Laid-open No. 2003-244343 is used, in remote-controlling the portable terminal device on the operation screen displayed in the in-vehicle device, only one virtual input key on the operation screen corresponds to only one input key on the portable terminal device. Therefore, operability of the remote control is the same as that of a direct operation, and the remote control does not contribute to improve the operability of the portable terminal from direct operation of the portable terminal.

Taking these disadvantages into consideration, challenges in remote-controlling a portable terminal device by using an in-vehicle device are to realize an in-vehicle device, a remote control system, and a remote control method which allow for improving the operability of the portable terminal device in comparison with direct operation of the portable terminal device, and at the same time, allow for efficient utilization of a display area of the in-vehicle device. The same challenge exists in remote control of various types of devices having an input interface, as well as in the remote control of the portable terminal device.

### SUMMARY OF THE INVENTION

It is an object of the present invention to at least partially solve the problems in the conventional technology.

An in-vehicle device according to one aspect of the present invention is an in-vehicle device which remote-controls a portable terminal device, and includes a layout-information acquiring unit that acquires layout information of input keys of the portable terminal device, an input/output unit that includes a touch panel display displaying an image and receiving a user input, a relating unit that relates each input key included in the layout information to a predetermined area on the touch panel display, a combination display unit that displays in the touch panel display a layout screen of the each input key related by the relating unit to a predetermined area on the touch panel display, a converting unit that converts, based on the layout information, an input to the touch panel display into an output signal or a combination of the output signals corresponding to a pressing operation of the input key, and a transmitting unit that transmits the output signal obtained as a result of conversion by the converting unit to the portable terminal device.

Further, a remote control system according to another aspect of the present invention is a remote control system for an in-vehicle device that remote-controls a portable terminal device. In the remote control system, the in-vehicle device includes a layout-information acquiring unit that acquires layout information of input keys of the portable terminal device, an input/output unit that includes a touch panel display displaying an image and receiving a user input, a relating unit that relates each input key included in the layout information to a predetermined area on the touch panel display, a combination display unit that displays in the touch panel display a layout screen of the each input key related by the relating unit to a predetermined area on the touch panel display, a converting unit that converts, based on the layout information, an input to the touch panel display into an output signal or a combination of the output signals corresponding to a pressing operation of the input key, and a transmitting unit that transmits the output signal obtained as a result of conversion by the converting unit to the portable terminal device. In the remote control system, the portable terminal device includes a notifying unit that notifies the layout information to the in-vehicle device, and a remote input unit that receives the output signal sent from the in-vehicle device by regarding the output signal as an output signal corresponding to a pressing operation of the input key of the portable terminal device.

Further, a remote control system according to still another aspect of the present invention is a remote control system which causes an operation key for remote controlling a portable terminal device to be displayed in a display/input unit of an in-vehicle device linked with the portable terminal device. The remote control system includes an acquiring unit that acquires operation key information including information of non-common operation keys which are operation keys corresponding to a device type of the portable terminal device and not common to other device types, a display controller causing an operation key to be displayed in the display/input unit of the in-vehicle device based on the operation key information acquired by the acquiring unit, and an operation converting unit that converts an operation to an operation key displayed in the display/input unit by the display controller into a command corresponding to the operation.

Further, a remote control method according to still another aspect of the present invention is a method for remote-controlling a portable terminal device to be applied to a remote control system causing an operation key for remote-controlling the portable terminal device to be displayed in a display/input unit of an in-vehicle device linked with the portable terminal device. The remote control method includes acquiring operation key information including information of non-common operation keys which are operation keys corresponding to a device type of the portable terminal device and not common to other device types, causing an operation key to be displayed in the display/input unit of the in-vehicle device based on the operation key information acquired in the acquiring, and converting an operation to an operation key displayed in the display/input unit into a command corresponding to the operation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are schematic diagrams of a remote control system according to a first embodiment of the present invention;

FIG. 2 is a block diagram of a configuration of various devices included in the remote control system according to the first embodiment;

FIGS. 3A and 3B depict various operation switches of an in-vehicle device and a portable terminal device according to the first embodiment;

FIGS. 4A and 4B depict an example of a relationship between input keys on the portable terminal device and hardware switches on the in-vehicle device;

FIGS. 5A to 5C depict an example of a relationship between an arrow key on the portable terminal device and a virtual switch on a touch panel display;

FIG. 6 is a schematic diagram of a pseudo-diagonal-shift operation process using a virtual switch;

FIGS. 7A to 7C depict an example of a relationship between a ten-key on the portable terminal device and a virtual switch on the touch panel display;

FIGS. 8A and 8B depict an example of superimposition of an application screen and an operation screen;

FIG. 9 is a flowchart of a process procedure of a remote-control initialization process;

FIG. 10 is a flowchart of a process procedure of a pseudo-diagonal-shift operation process;

FIG. 11 is a schematic diagram of a remote control system according to a second embodiment of the present invention;

FIG. 12 is a functional block diagram of a configuration of various devices constituting the remote control system according to the second embodiment;

FIGS. 13A and 13B depict various operation switches of an in-vehicle device and a portable terminal device according to the second embodiment;

FIGS. 14A and 14B depict an example of an operation key image including non-common operation keys;

FIG. 15 depicts an operation sequence of an operation-key-image acquiring process according to the second embodiment;

FIG. 16 depicts a control sequence between the in-vehicle device and the portable terminal device according to the second embodiment;

FIG. 17 is an example of a usage mode of a MULTI key in the second embodiment;

FIG. 18 depicts an outline of a remote control system according to a third embodiment of the present invention;

FIG. 19 is a functional block diagram of a configuration of various devices constituting the remote control system according to the third embodiment;

FIGS. 20A to 20C are schematic diagrams for explaining non-common operation-key information;

FIG. 21 depicts a control sequence between an in-vehicle device and a portable terminal device according to the third embodiment; and

FIG. 22 is an example of a usage mode of a MULTI key in the third embodiment.

### DETAILED DESCRIPTION OF THE PREFERRED EMBODIMENTS

Exemplary embodiments of an in-vehicle device and a remote control system according to the present invention will be explained below in detail with reference to the accompanying drawings. In a remote control system described below by way of example, an in-vehicle device which is incorporated in a vehicle and referred to as Display Audio (DA) is linked by short-distance wireless communication function to a portable terminal device which executes application such as navi-application, and the portable terminal device is remote-controlled through the in-vehicle device.

The DA is an in-vehicle device which has only basic functions such as a display function, an audio reproduction function, and a communication function with the portable terminal device. However, the DA works as multifunctional device when linked to the portable terminal device. In the embodiments explained below, while the device to be remote-controlled is a portable terminal device, various types of devices having an input interface can be also a remote-controlled device.

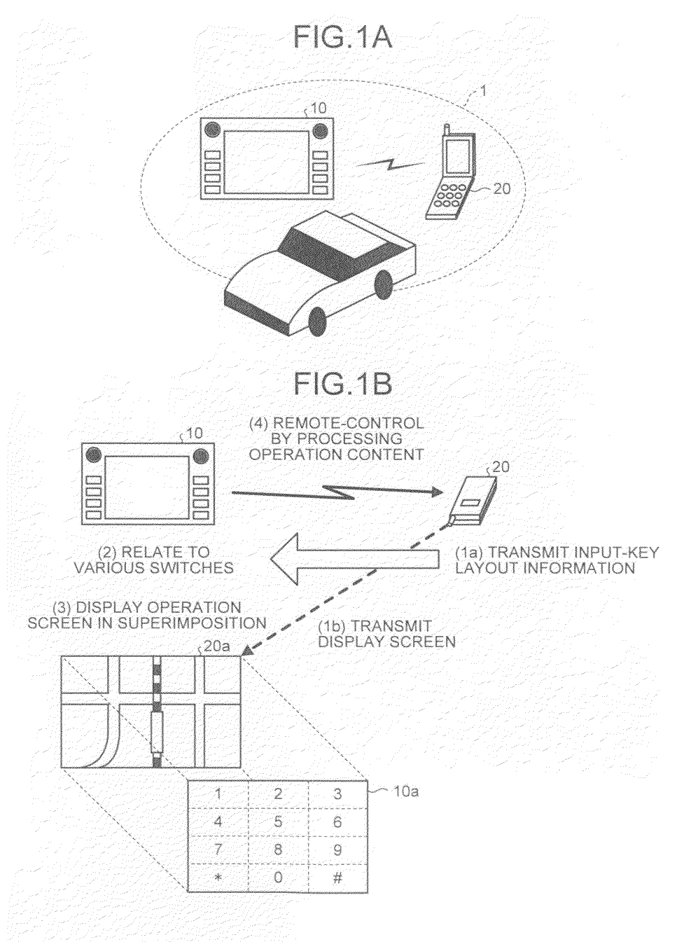

FIGS. 1A and 1B are schematic diagrams of a remote control system 1 according to a first embodiment of the present invention. FIG. 1A depicts devices constituting the remote control system 1, and FIG. 1B depicts an outline of a process performed by the remote control system 1.

As illustrated in FIG. 1A, the remote control system 1 includes an in-vehicle device 10 having a customizable “virtual switch” displayed on a touch panel display and a “hardware switch” such as a button and a dial, and a portable terminal device 20 such as a mobile telephone carried by an occupant. The in-vehicle device 10 and the portable terminal device 20 are linked with each other by the short-distance wireless communication function such as Bluetooth.

When a communication link between the in-vehicle device 10 and the portable terminal device 20 is established, the portable terminal device 20 transmits input-key layout information including a layout of input keys to the in-vehicle device 10 as illustrated in FIG. 1B (see (1a) in FIG. 1B).

The in-vehicle device 10 receives the input-key layout information, and relates the input keys on the portable terminal device 20 to various switches on the in-vehicle device 10, respectively (see (2) in FIG. 1B). Specifically, the in-vehicle device 10 relates the “virtual switch” described above to the input key on the portable terminal device 20, and relates the “hardware switch” described above to the input key on the portable terminal device 20.

Subsequently, the in-vehicle device 10 generates an operation screen 10a to remote-control the portable terminal device 20. While FIG. 1B depicts the operation screen 10a having a so-called ten-key (numeric keypad) as an example, the in-vehicle device 10 generates plural types of operation screens such as an operation screen having an arrow key. In the first embodiment, while the in-vehicle device 10 is explained to generate the operation screen to remote-control the portable terminal device 20, the portable terminal device 20 can also generate the operation screen.

When an application program such as a navi-application operating on the portable terminal device 20 is liked with the in-vehicle device 10, the portable terminal device 20 transmits to the in-vehicle device 10, as appropriate, a display screen 20a which is usually displayed in the own device (the portable terminal device 20) (see (1b) in FIG. 1B).

The in-vehicle device 10 displays the display screen 20a sent from the portable terminal device 20, in superimposition with the operation screen 10a (see (3) in FIG. 1B). The operation screen 10a is subjected to image processing and made translucent. Therefore, even when the operation screen 10a is displayed on the display screen 20a in superimposition, visibility of the display screen 20a is not impaired. The operation screen 10a can be displayed in superimposition only when a predetermined operation is performed to a touch panel display.

As explained above, the in-vehicle device 10 remote-controls the portable terminal device 20 by displaying the operation screen 10a in superimposition on the display screen 20a. The in-vehicle device 10 can also remote-control the portable terminal device 20 after processing operation content of input operation performed to the in-vehicle device 10 (see (4) FIG. 1B).

For example, when it is desired to scroll a map screen of a navi-application to a diagonal direction, in many cases, the portable terminal device 20 does not have an input key to instruct shifting to a diagonal direction. In this case, the in-vehicle device 10 converts the operation content of the operation screen 10a to a combination of the input keys actually present on the portable terminal device 20, thereby achieving a pseudo diagonal-shift operation.

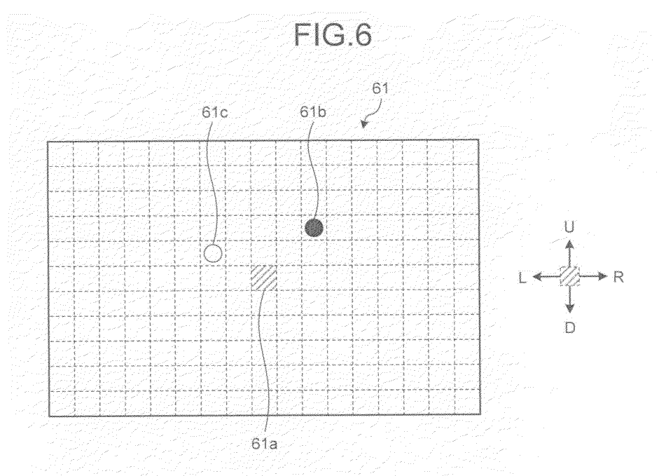

That is, according to the remote control system 1 of the first embodiment, operability of remote-controlling the portable terminal device 20 via the in-vehicle device 10 can be improved in comparison with the direct operation of the portable terminal device 20. The pseudo diagonal-shift operation is described later with reference to FIG. 6 or the like.

As described above, the remote control system 1 according to the first embodiment displays the operation screen 10a for remote-control of the portable terminal device 20 in superimposition on the display screen 20a of the application while adjusting to an input-key layout of each portable terminal device 20; the input-key layout is different for each type of the portable terminal device 20. Therefore, a display area of the touch panel display can be effectively used.

The “hardware switches” of the in-vehicle device 10 as well as the “virtual switches” on the touch panel display are related to the input keys of the portable terminal device 20. Therefore, it is possible to remote-control the portable terminal device 20 only by operating the “hardware switch”, without causing the “virtual switch” to be displayed on the touch panel display. Accordingly, the display area of the touch panel display can be used more effectively.

Further, because the in-vehicle device 10 further performs a process of converting the operation content of the “virtual switch” or the “hardware switch” into a combination of the input keys on the portable terminal device 20, operability of remote control can be improved.

The type and layout of the input key on the portable terminal device 20 are different for each telecommunication carrier or for each manufacturer. This difference can be absorbed by the input-key layout information described above.

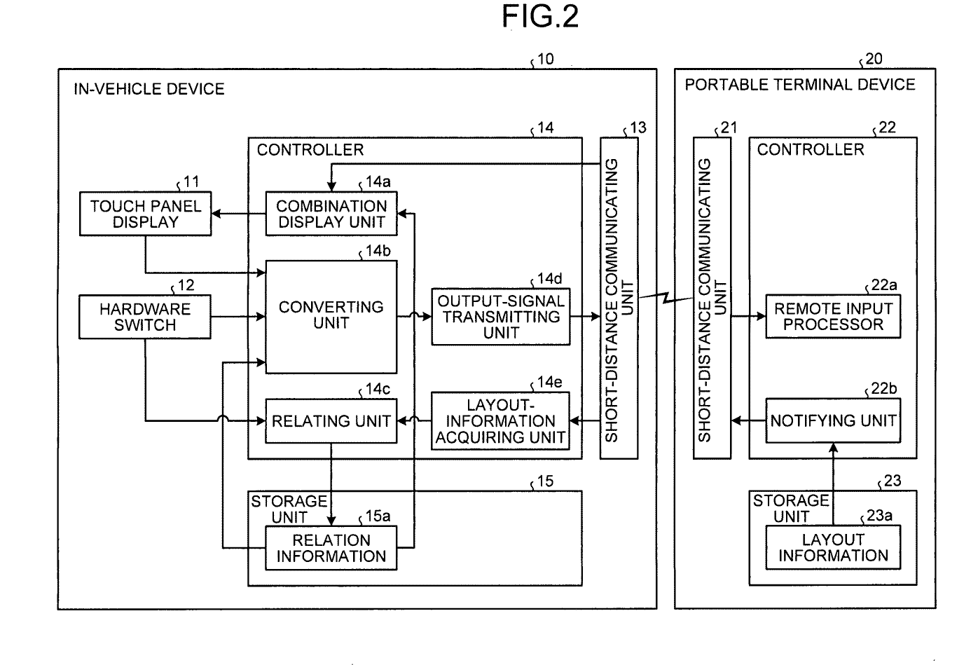

FIG. 2 is a block diagram of a configuration of various devices included in the remote control system 1. As illustrated in FIG. 2, the remote control system 1 includes the in-vehicle device 10 and the portable terminal device 20. FIG. 2 depicts only constituent elements necessary to explain characteristics of the in-vehicle device 10 and the portable terminal device 20, and omits descriptions of general constituent elements. In addition, while FIG. 2 depicts only one portable terminal device 20, plurality of the portable terminal devices 20 can be provided.

A configuration of the in-vehicle device 10 is explained first. The in-vehicle device 10 includes a touch panel display 11, a hardware switch 12, a short-distance communicating unit 13, a controller 14, and a storage unit 15. The controller 14 includes a combination display unit 14a, a converting unit 14b, a relating unit 14c, an output-signal transmitting unit 14d, and a layout-information acquiring unit 14e. The storage unit 15 stores relation information 15a.

The touch panel display 11 is an input/output device including a display for displaying various images and a touch panel for receiving an input provided on a surface of the display. The hardware switch 12 is an input device such as a dial and a button provided around the touch panel display 11.

Normally, a character string indicating its function is provided on the hardware switch 12 or near the hardware switch 12. For example, a volume adjusting dial has a character string of “VOL”, and a button to set audio to be muted has a character string of “MUTE”.

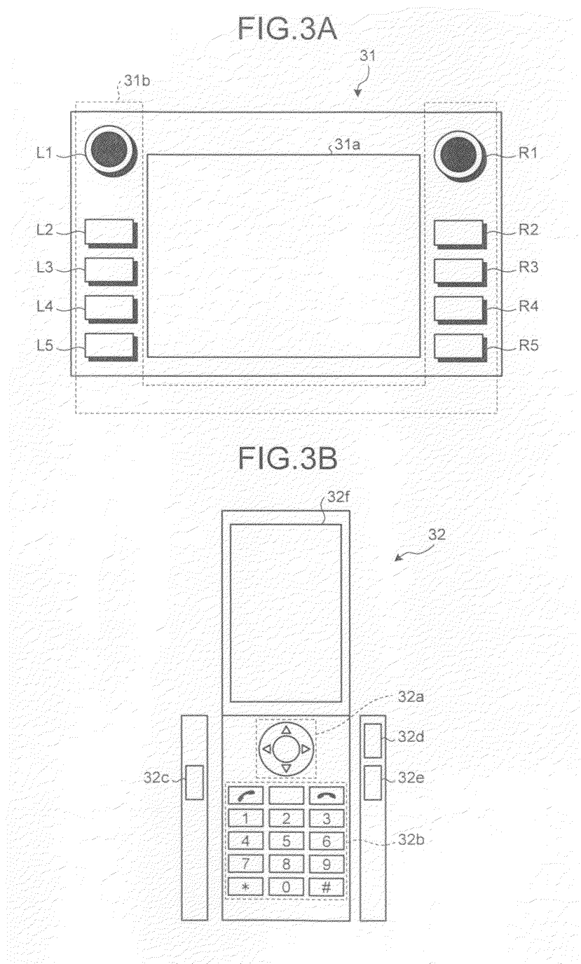

Operation switches provided in the in-vehicle device 10 and the portable terminal device 20 are explained with reference to FIGS. 3A and 3B. FIGS. 3A and 3B depict various operation switches of the in-vehicle device 10 and the portable terminal device 20. FIG. 3A depicts various operation switches of the in-vehicle device 10, and FIG. 3B depicts various operation switches of the portable terminal device 20.

As illustrated in FIG. 3A, a touch panel display 31a (corresponding to the touch panel display 11 in FIG. 2) is arranged on a front surface 31 of the in-vehicle device 10. A hardware switch 31b (corresponding to the hardware switch 12 in FIG. 2) is arranged around the touch panel display 31a.

The hardware switch 31b includes various types of switches such as a dial and a button. In the example illustrated in FIG. 3A, a dial L1, a button L2, a button L3, a button L4, and a button L5 are arranged at the left side of the touch panel display 31a, and a dial R1, a button R2, a button R3, a button R4, and a button R5 are arranged at the right side of the touch panel display 31a.

As illustrated in FIG. 3B, an arrow key 32a to instruct shifting in directions of up, down, right, and left, and a ten-key 32b are arranged on an operation surface 32 of the portable terminal device 20. A side-surface key 32c is arranged on a left surface to the operation surface, and a side-surface key 32d and a side-surface key 32e are arranged on a right surface to the operation surface.

The portable terminal device 20 has a display 32f. The display 32f does not display an output screen of an application during linking with the in-vehicle device 10, and comes into a display pause state or displays a message of “linking” to indicate that the portable terminal device 20 is being linked with the in-vehicle device 10.

The layout and the type of the input keys included in the arrow key 32a and the ten-key 32b, and whether the various types of side-surface keys are present or not are usually different for each type of the portable terminal device 20. There are also “common operation keys” of which layout and type are used in common for all of the portable terminal devices 20, such as numeric keys from “0” to “9”, a “*” key, and a “#” key included in the ten-key 32b. Hereinafter, input keys other than these “common operation keys” are described as “non-common operation keys”.

Referring back to FIG. 2, explanations of the configuration of the in-vehicle device 10 are continued. The short-distance communicating unit 13 establishes a communication link with the portable terminal device 20 by using the short-distance wireless communication such as Bluetooth, and performs a communication process between the in-vehicle device 10 and the portable terminal device 20 by using the established communication link. Bluetooth is a short-distance wireless-communication standard to perform wireless communications in a radius of about dozens of meters by using a frequency band of 2.4 gigahertz. In recent years, Bluetooth is widely applied to electronic devices such as mobile telephones and personal computers.

In the first embodiment, only an example where the communications between the in-vehicle device 10 and the portable terminal device 20 is performed by using Bluetooth is explained. However, other wireless communication standards such as Wi-Fi® and ZigBee® can be also used. Alternatively, wired communications can be performed between the in-vehicle device 10 and the portable terminal device 20.

The controller 14 is a processor that relates the virtual switch displayed in the touch panel display 11 and the hardware switch 12 provided on the operation screen of the in-vehicle device 10 to various types of input keys (see FIGS. 3A and 3B) on the portable terminal device 20, and converts the input received by the touch panel display 11 into an output signal corresponding to the operation of the input key on the portable terminal device 20, and transmits the output signal obtained by conversion.

The combination display unit 14a is a processor that combines a received application screen sent from the portable terminal device 20 via the short-distance communicating unit 13 with the operation screen included in the relation information 15a, and outputs a combined screen to the touch panel display 11.

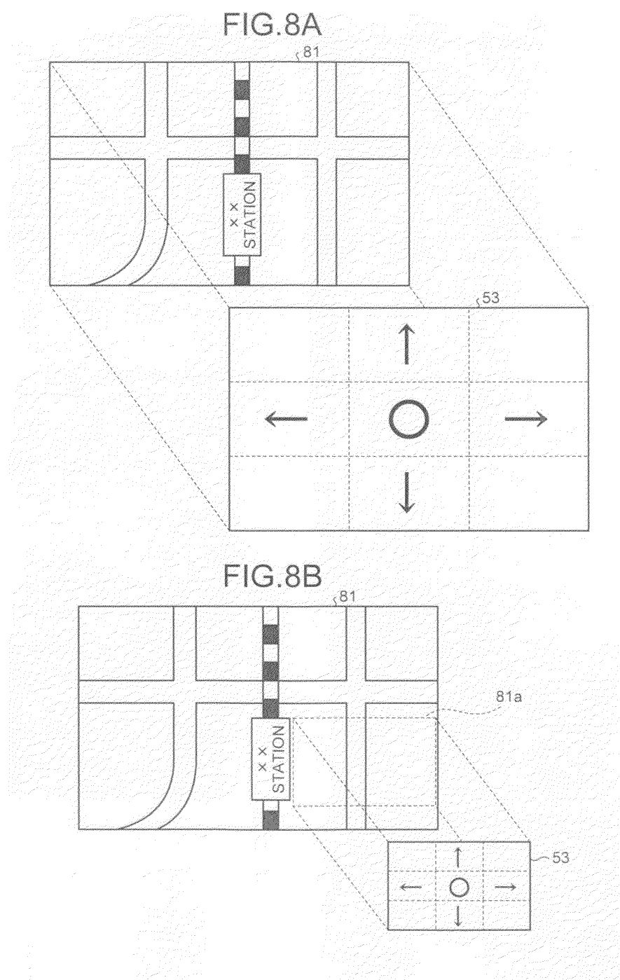

For example, when the touch panel display 11 or the hardware switch 12 receives a predetermined input, the combination display unit 14a displays an opaque image-processed operation screen on the application screen in superimposition. An example of the superimposed display is described later with reference to FIGS. 8A and 8B.

The converting unit 14b is a processor that converts, based on the relation information 15a, operation of the virtual switch on the touch panel display 11 or operation of the hardware switch 12 in the in-vehicle device 10 into an output signal corresponding to the operation of the input key (input key on the portable terminal device 20) related to the virtual switch or the hardware switch 12.

The converting unit 14b also delivers the output signal obtained by conversion to the output-signal transmitting unit 14d. The converting unit 14b performs a process of the pseudo diagonal-shift operation described above, and this is described later with reference to FIG. 6 or the like.

The relating unit 14c relates the virtual switch displayed on the touch panel display 11 to various input keys (see FIGS. 3A and 3B) on the portable terminal device 20, and relates each of the hardware switch 12 to the input key on the portable terminal device 20, based on layout information 23a that the layout-information acquiring unit 14e receives from the portable terminal device 20. The relating unit 14c further stores a related result in the storage unit 15 as the relation information 15a.

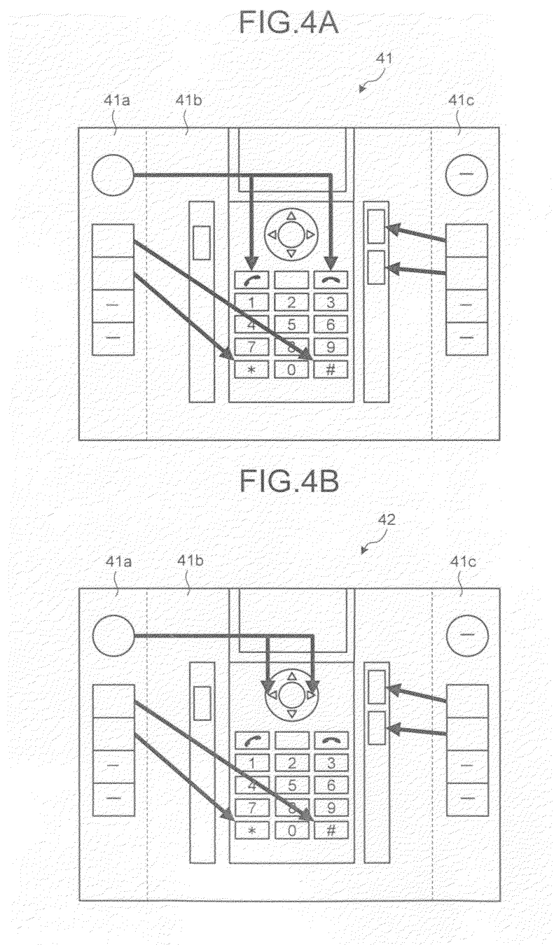

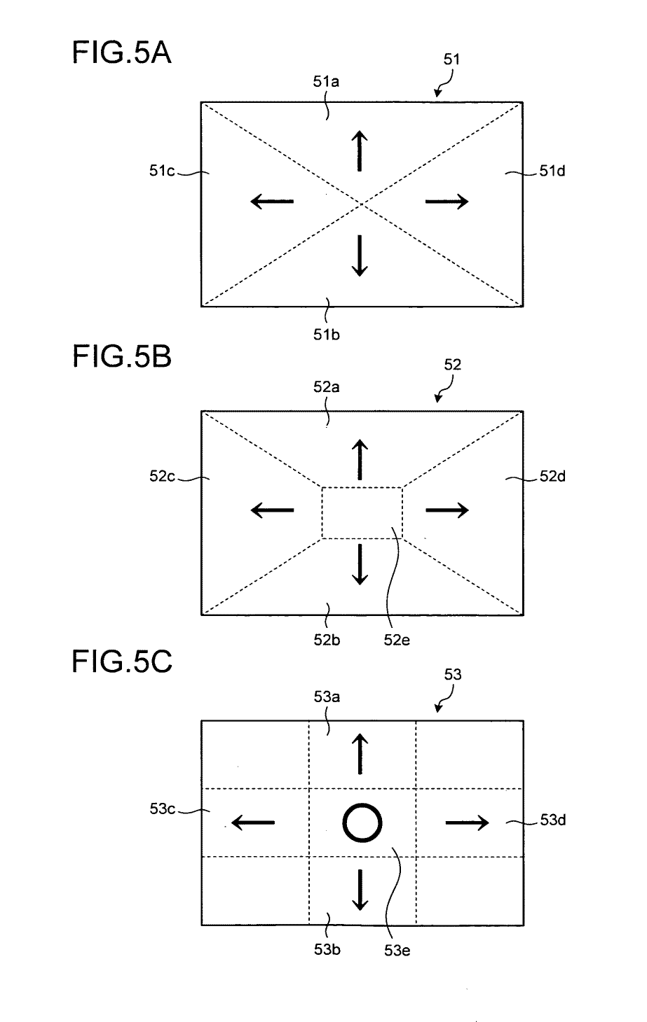

A relating process performed by the relating unit 14c is explained with reference to FIGS. 4A and 4B and FIGS. 5A, 5B, and 5C. FIGS. 4A and 4B depict a relationship between the input keys on the portable terminal device 20 and the hardware switch 12 on the in-vehicle device 10. FIG. 4A is an example of a relationship, and FIG. 4B depicts a modification of the relationship.

As illustrated in FIG. 4A, when a user wishes to confirm a relationship, the touch panel display 11 displays a standard relation screen 41. A display area 41a displays an image of the hardware switch 12 arranged at the left of the touch panel display 11 (see L1 to L5 in FIG. 3A), and a display area 41c displays an image of the hardware switch 12 arranged at the right of the touch panel display 11 (see R1 to R5 in FIG. 3A).

As explained above, by displaying the images of the hardware switch 12 in the display area 41a and the display area 41c, a user can easily understand a relationship, even when a character string arranged on the hardware switch 12 is different from a character string arranged on each input key of the portable terminal device 20.

A display area 41b displays a received input-key layout image (see FIG. 3B) based on the layout information 23a sent from the portable terminal device 20. An arrowhead is also displayed to indicate a relationship between the hardware switch 12 in the display area 41a or in the display area 41c and the input key of the portable terminal device 20.

As illustrated in FIG. 4B, a user can also change the relationship (see a relation screen 42 in FIG. 4B). For example, FIG. 4A depicts that the dial L1 in the display area 41a (see FIG. 3A) is related to a talk key and an end-talk key of the portable terminal device 20. FIG. 4B depicts a changed relationship that the dial L1 in the display area 41a is related to a leftward-shift key and a rightward-shift key of the arrow key.

As explained above, by relating the hardware switch 12 of the in-vehicle device 10 and the input key of the portable terminal device 20, the portable terminal device 20 can be remote-controlled by operating the hardware switch 12. The relation screens 41 and 42 depicted in FIGS. 4A and 4B can be displayed only when a user wishes to confirm the relationship. Therefore, these screens do not impair the visibility of the application screen.

FIGS. 5A to 5C depict an example of a relationship between the arrow key on the portable terminal device 20 and the virtual switch on the touch panel display 11. FIGS. 5A to 5C depict a variation of the relationship.

FIG. 5A depicts an operation screen 51 in which a display area of the touch panel display 11 divided into four part areas by diagonal lines are related to the arrow key; an upward shift key is related to a part area 51a, a downward shift key is related to a part area 51b, a leftward shift key is related to a part area 51c, and a rightward shift key is related to a part area 51d. To display the operation screen 51 in the touch panel display 11, only lines representing the diagonal lines can be also displayed.

FIG. 5B depicts an operation screen 52 in which a confirm key of the arrow key on the portable terminal device 20 is further allocated to the screen illustrated in FIG. 5A. As depicted in FIG. 5B, the upward shift key is related to a part area 52a, the downward shift key is related to a part area 52b, the leftward shift key is related to a part area 52c, the rightward shift key is related to a part area 52d, and the confirm key is related to a part area 52e.

FIG. 5C depicts an operation screen 53 in which the shift keys and the confirm key are allocated to part areas different from the part areas depicted in FIG. 5B. As depicted in FIG. 5C, the upward shift key is related to a part area 53a, the downward shift key is related to a part area 53b, the leftward shift key is related to a part area 53c, the rightward shift key is related to a part area 53d, and the confirm key is related to a part area 53e.

To display the operation screen 52 depicted in FIG. 5B or the operation screen 53 depicted in FIG. 5C in the touch panel display 11, only lines dividing the display area into the part areas can be displayed in a similar manner to the display of the operation screen 51 depicted in FIG. 5A.

Referring back to FIG. 2, the output-signal transmitting unit 14d is explained. The output-signal transmitting unit 14d is a processor that transmits a received output signal after conversion sent from the converting unit 14b (i.e., output signal provided when the input key on the portable terminal device 20 is operated) to the portable terminal device 20 via the short-distance communicating unit 13. The layout-information acquiring unit 14e is a processor that delivers the layout information 23a sent from the portable terminal device 20 via the short-distance communicating unit 13 to the relating unit 14c.

In the first embodiment, it is explained that the output-signal transmitting unit 14d of the in-vehicle device 10 transmits an output signal, which is an output signal provided in response to the operation on the input key of the portable terminal device 20, to the portable terminal device 20. Alternatively, only operation information indicating the operated input key can be transmitted to the portable terminal device 20. In this case, a remote input processor 22a of the portable terminal device 20 converts the received operation information sent from the in-vehicle device 10 into an output signal corresponding to the input key.

The storage unit 15 is configured by a storage device such as a nonvolatile memory and a hard disk drive, and stores the relation information 15a. The relation information 15a includes information on a relationship between the virtual switch displayed in the touch panel display 11 and various input keys (see FIGS. 3A and 3B) on the portable terminal device 20, and a relationship between the hardware switch 12 and various input keys (see FIGS. 3A and 3B) on the portable terminal device 20.

A configuration of the portable terminal device 20 is explained next. As depicted in FIG. 2, the portable terminal device 20 includes a short-distance communicating unit 21, a controller 22, and a storage unit 23. The controller 22 includes the remote input processor 22a, and a notifying unit 22b. The storage unit 23 stores the layout information 23a.

The short-distance communicating unit 21 establishes a communication link with the in-vehicle device 10 by using the short-distance wireless communication such as Bluetooth, and performs a communication process between the portable terminal device 20 and the in-vehicle device 10 by using the established communication link, in a similar manner to that of the short-distance communicating unit 13 of the in-vehicle device 10.

The controller 22 is a processor that transmits to the in-vehicle device 10 the layout information 23a including an input-key layout of the portable terminal device 20 and an output signal corresponding to the operation of each input key, and allocates to each application a received remote control command (an output signal or an output signal sequence corresponding to the input key) sent from the in-vehicle device 10.

The remote input processor 22a allocates to each application, as an input signal to the application, the remote control command (an output signal or an output signal sequence corresponding to the input key) sent from the in-vehicle device 10 via the short-distance communicating unit 21. With this arrangement, each application can operate in a similar manner to that when the input key of the portable terminal device 20 is directly operated.

The notifying unit 22b is a processor that transmits the layout information 23a of the storage unit 23 to the in-vehicle device 10 via the short-distance communicating unit 21. The storage unit 23 is configured by a storage device such as a nonvolatile memory, and stores the layout information 23a.

The layout information 23a includes the input-key layout of the portable terminal device 20 and an output signal corresponding to the operation of each input key. For example, the layout information 23a includes the input-key layout in an image format as illustrated in the display area of FIG. 4A or FIG. 4B.

The layout information 23a is different for each type of the portable terminal device 20, and can be acquired by downloading the layout information 23a of the own device from a server device on the Internet. Alternatively, the layout information 23a can be stored in the storage device 23 at a manufacturing time of the portable terminal device 20.

A pseudo-diagonal-shift operation process performed by the converting unit 14b of the in-vehicle device 10 is explained next with reference to FIG. 6. FIG. 6 is a schematic diagram of the pseudo-diagonal-shift operation process using a virtual switch. An operation screen 61 depicted in FIG. 6 is displayed in the touch panel display 11 in a similar manner to each operation screen depicted in FIGS. 5A to 5C.

As illustrated in FIG. 6, in achieving the pseudo diagonal-shift, a display area of the touch panel display 11 is divided into N×M squares, for example. A shaded block is a center block 61a of the display area. Assume that a command to shift from the center block 61a upward by one block is “U”, a command to shift from the center block 61a downward by one block is “D”, a command to shift from the center block 61a leftward by one block is “L”, and a command to shift from the center block 61a rightward by one block is “R”.

The converting unit 14b generates a string of commands as described above depending on how far a block touched by a user is shifted from the center block 61a. For example, when a block 61b depicted in FIG. 6 is touched, the block 61b is two blocks rightward and two blocks upward from the center block 61a. In this case, the converting unit 14b generates two commands R and two commands U.

With this arrangement, even when the portable terminal device 20 does not have an input key to perform diagonal-shifting, the pseudo-diagonal-shift operation can be achieved by combining the upward-, downward-, rightward-, and leftward-shift keys.

On generating a command string by combining the commands, the converting unit 14b adjusts the order of the commands so that the number of same consecutive commands is minimum. For example, when the block 61b is operated, commands are set in the order of the command R, the command U, the command R, and the command U, or commands are set in the order of the command U, the command R, the command U, and the command R.

With this arrangement, a screen scroll in a diagonal direction can be performed smoothly, even when shift commands to directions of up, down, right, and left are combined. When a block 61c depicted in FIG. 6 is operated, the converting unit 14b outputs a command string in the order of the command L, the command U, and the command L.

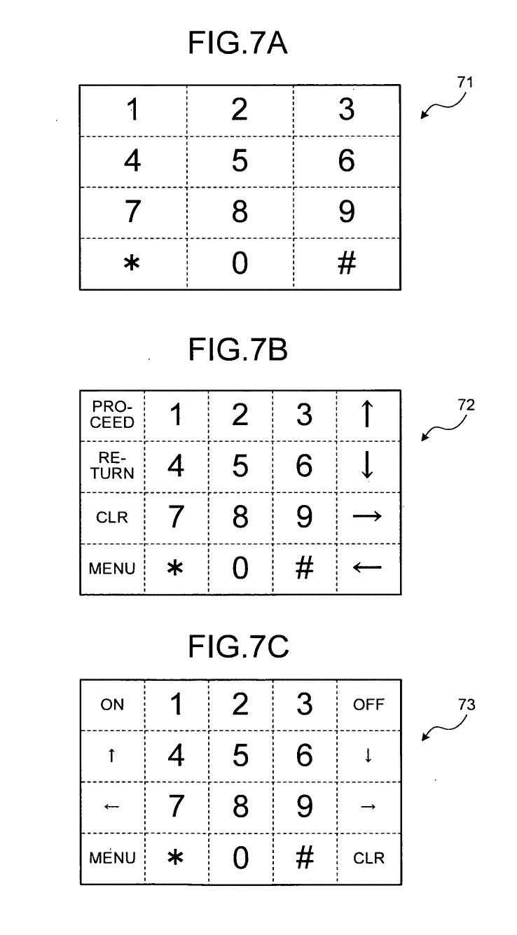

In the above explanations, display of the operation screen corresponding to the arrow key of the portable terminal device 20 in the touch panel display 11 has been explained (see FIGS. 5A to 5C, for example). It is also possible to display an operation screen corresponding to other input keys such as the ten-key. FIGS. 7A to 7C depict an example of a relationship between the ten-key on the portable terminal device 20 and the virtual switch on the touch panel display 11.

FIG. 7A depicts an operation screen 71 including virtual switches corresponding to the numeric keys from “0” to “9”, the “*” key, and the “#” key. To display the operation screen 71 in the touch panel display 11, only lines indicating separation of virtual switches can be displayed.

FIG. 7B depicts an operation screen 72 including virtual switches corresponding to the non-common operation keys such as a “proceed” key and a “return” key in addition to the keys depicted in FIG. 7A. Types and layout of keys included in the operation screen 72 can be customized by a user in a similar manner to that depicted in FIGS. 4A and 4B.

For example, as shown by an operation screen 73 in FIG. 7C, the operation screen can include the non-common operation keys such as an “ON” key and an “OFF” key and a layout of shift keys such as an upward-arrow operation key can be different from the operation screen 72 depicted in FIG. 7B.

To display in the touch panel display 11 the operation screen 72 depicted in FIG. 7B or the operation screen 73 depicted in FIG. 7C, only lines indicating separation of virtual switches can be displayed in a similar manner to the operation screen 71 depicted in FIG. 7A.

An image combining process performed by the combination display unit 14a of the in-vehicle device 10 is explained with reference to FIGS. 8A and 8B. FIGS. 8A and 8B depict an example of superimposition of an application screen and an operation screen. FIGS. 8A and 8B depict an example where the operation screen 53 of FIG. 5C is superimposed on an application screen 81.

As depicted in FIG. 8A, the combination display unit 14a combines the operation screen 53 on the application screen 81 sent from the portable terminal device 20. The operation screen 53 is processed to be translucent, and thus even when the operation screen 53 is displayed in superimposition, the application screen 81 can be visually confirmed. The operation screen 53 can be displayed only when a predetermined operation is performed to the touch panel display 11 or the hardware switch 12.

Further, as illustrated in FIG. 8B, the operation screen 53 can be displayed in superimposition on a predetermined part area 81a of the application screen 81. While FIGS. 8A and 8B depict superimposition of the operation screen 53 illustrated in FIG. 5C on the application screen 81, the operation screen 51 of FIG. 5A, the operation screen 52 of FIG. 5B, the operation screen 61 of FIG. 6, the operation screen 71 of FIG. 7A, the operation screen 72 of FIG. 7B, or the operation screen 73 of FIG. 7C can be displayed in superimposition with the application screen 81. Further, more than one operation screens may be displayed in superimposition with the application screen 81.

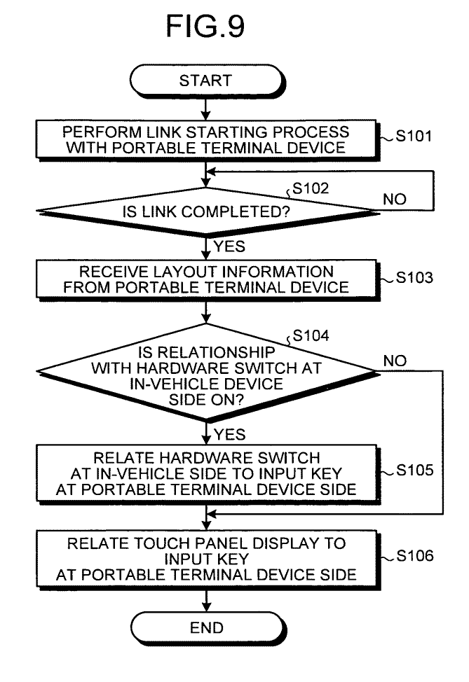

A process procedure of an initial process when the in-vehicle device 10 remote-controls the portable terminal device 20 is explained next with reference to FIG. 9. FIG. 9 is a flowchart of a process procedure of a remote-control initialization process. As illustrated in FIG. 9, the short-distance communicating unit 13 performs a link starting process with the portable terminal device 20 (Step S101), and determines whether the link is completed (Step S102).

When the link is completed (YES at Step S102), the layout-information acquiring unit 14e receives the layout information 23a from the portable terminal device 20 (Step S103). When a determination condition at Step S102 is not satisfied (NO at Step S102), the process at Step S102 is repeated.

The relating unit 14c then determines whether a relationship with the hardware switch 12 of the in-vehicle device 10 is set (i.e., whether the relationship is ON) (Step S104). When the relationship is ON (YES at Step S104), the relating unit 14c relates the hardware switch 12 of the in-vehicle device 10 side to the input key of the portable terminal device 20 side (Step S105).

The relating unit 14c then relates the touch panel display 11 to the input key of the portable terminal device 20 side (Step S106), and ends the process. When a determination condition at Step S104 is not satisfied (NO at Step 104), the relating unit 14c performs the process at Step S106 without performing the process at Step S105, and ends the process.

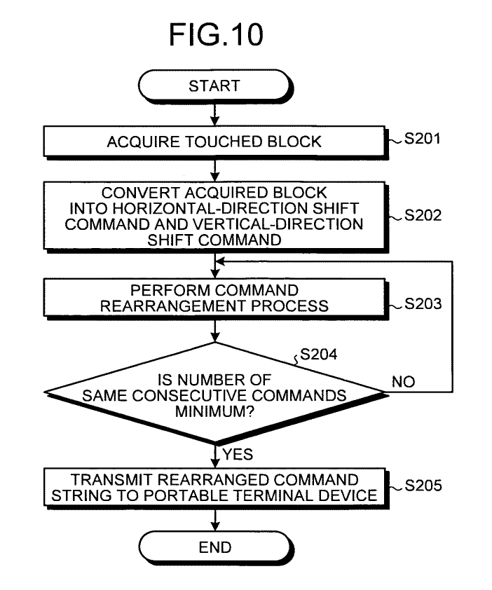

A process procedure of the pseudo-diagonal-shift operation process performed by the converting unit 14b of the in-vehicle device 10 is explained next with reference to FIG. 10. FIG. 10 is a flowchart of the process procedure of the pseudo-diagonal-shift operation process. FIG. 10 depicts a process procedure performed when a user operates the operation screen 61 depicted in FIG. 6.

As depicted in FIG. 10, the converting unit 14b acquires a block touched by the user (Step S201), and converts the block into a horizontal-direction shift command and a vertical-direction shift command (Step S202). The converting unit 14b performs a command rearrangement process (Step S203), and determines whether the number of same consecutive commands is minimum (Step S204).

When the number the same command continues is minimum (YES at Step S204), the converting unit 14b transmits a rearranged command string to the portable terminal device 20 (Step S205), and ends the process. When a determination condition of Step S204 is not satisfied (NO at Step S204), the process returns to Step S203, and the converting unit 14b rearranges commands again, and repeats the process of Step S204.

As described above, in the first embodiment, the in-vehicle device is configured as follows. The layout-information acquiring unit acquires layout information of the input key of the portable terminal device. The relating unit relates each input key included in the layout information to a predetermined area on the touch panel display, which displays an image and receives an input by a user. The combination display unit displays in superimposition the display screen generated by the portable terminal device and the layout screen of each input key related by the relating unit to a predetermined area on the touch panel display. The converting unit converts the input to the touch panel display into an output signal or a combination of output signals when the input key is pressed, based on the layout information. The output-signal transmitting unit transmits the output signal obtained by conversion to the portable terminal device.

The portable terminal device is configured so that the notifying unit notifies layout information to the in-vehicle device, and the remote input processor receives a command or a command string sent from the in-vehicle device as a pseudo input command.

Therefore, a display area of the in-vehicle device can be effectively used, and operability can be further improved in comparison with the direct operation of the portable terminal device, by displaying in superimposition the display screen and the operation screen of the device to be operated as appropriate, and by converting the input to the operation screen into a combination of output signals when plural input keys are pressed.

In the first embodiment described above, the portable terminal device downloads from a server device on the Internet the layout information of input keys, which is different for each telecommunication carrier and for each manufacturer, or stores the layout information in advance at a manufacturing time. In a second embodiment of the present invention, downloading the layout information different for each telecommunication carrier and for each manufacturer from a server device on the Internet is explained in detail. In the following explanations, the “layout information” described above is called “operation key information”. The “operation key information” includes information of the non-common operation keys different for telecommunication carrier and for each manufacturer of the portable terminal device.

According to the technique disclosed in Japanese Patent Application Laid-open No. 2003-244343, when a portable terminal device is remote-controlled via the operation key displayed in the in-vehicle device, only the common operation keys such as the arrow key and the alphanumeric keys provided commonly in the portable terminal devices of telecommunication carriers and manufacturers are displayed in the in-vehicle device. Because the range of operation on the portable terminal device is narrowed as a result, operability becomes impaired in comparison with that of the direct operation of the portable terminal device.

That is, the operation keys provided in the portable terminal device, such as the arrow key and the alphanumeric keys that perform basic operations are standardized. However, operation keys that perform an application operation specialized in a part of operation such as a function of short-cutting to a specific command and changing over an application to actively operate on a certain screen are various depending on difference of telecommunication carriers and manufacturers and a difference of manufacturing period even when telecommunication carriers and manufacturers are the same. Consequently, these keys are not uniformly standardized.

According to the technique disclosed in Japanese Patent Application Laid-open No. 2003-244343, these non-common operation keys not standardized depending on types of a portable terminal device cannot be displayed in the in-vehicle device, and only the common operation keys such as the arrow key and the alphanumeric keys can be displayed in the in-vehicle device.

When only such common operation keys are available, an occupant can perform only basic operations, and cannot perform advanced application operations that allow further convenience on the in-vehicle device side. For example, an operation required for achieving a target command may become complicated, or an application may not be usable unless another application running on the screen of the in-vehicle device is ended.

Therefore, in remote-controlling the portable terminal device through the operation key displayed in the in-vehicle device, one big question is how to realize in the in-vehicle device the non-common operation keys that vary depending on telecommunication carriers, manufacturers, and manufacturing period. This question arises not only for the in-vehicle system in which the in-vehicle device and portable terminal device are linked, but also for an information processing device linked with a portable terminal device.

An outline of a remote control system according to the second embodiment is explained first. This remote control system achieves multifunction in linkage with a portable terminal device while having only basic functions in an in-vehicle device among functions incorporated in a vehicle, and causes the in-vehicle device to remote-control the portable terminal device.

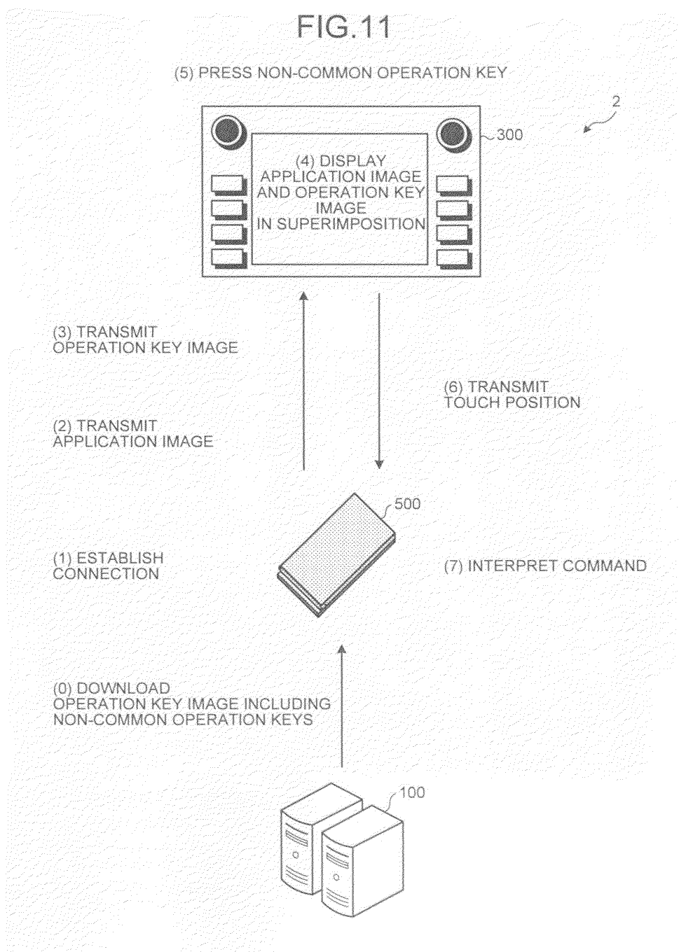

FIG. 11 is a schematic diagram of the remote control system according to the second embodiment. As illustrated in FIG. 11, a remote control system 2 includes a server device 100 provided by a manufacturer manufacturing portable terminal devices or a carrier as a telecommunication carrier, an in-vehicle device 300 mounted on a vehicle, and a portable terminal device 500 such as a mobile telephone and a personal handyphone system (PHS) held by an occupant of a vehicle.

In the remote control system 2, for the in-vehicle device 300 to call an output of various applications mounted in the portable terminal device 500, a portable application linking the in-vehicle device 300 and the portable terminal device 500 is installed in the portable terminal device 500. The portable application causes a touch panel of the in-vehicle device 300 to function as if the touch panel is a screen of the portable terminal device 500.

Further, the remote control system 2 causes the operation key provided in the portable terminal device 500 to be displayed in the touch panel of the in-vehicle device 300, detects pressing of the operation key, and executes a command. With this arrangement, the remote control system 2 virtually realizes on the in-vehicle device 300 the operation key provided in the portable terminal device 500, and receives remote-control of the portable terminal device 500 from the in-vehicle device 300.

The second embodiment is characterized in its manner of reproducing the non-common operation keys, which vary according to carriers, manufacturers, and manufacturing periods, in the in-vehicle device 300, in remote-controlling the portable terminal device 500 through the operation key displayed in the in-vehicle device 300.

Specifically, in the second embodiment, operation key information including information of operation keys, which correspond to a type of the portable terminal device 500 and which are the non-common operation keys not common among different types of portable terminal devices, is acquired. Based on the acquired operation-key information, the operation keys are displayed in the touch panel of the in-vehicle device 300. Operation to the operation keys displayed in the touch panel is converted into a command corresponding to the operation.

This is explained in detail. When the portable terminal device 500 is used by itself, the non-common operation keys can be directly operated, and hence there is no operational problem and the portable terminal device 500 basically does not need image information of the operation keys. On the other hand, in a specific state where the in-vehicle device 300 remote-controls the portable terminal device 500, the user has to perform input operation through the in-vehicle device 300, which is another device of the portable terminal device 500. To reproduce a unit corresponding to non-common operation keys of the portable terminal device 500 on the in-vehicle device 300, an image of the operation keys including the non-common operation keys is necessary.

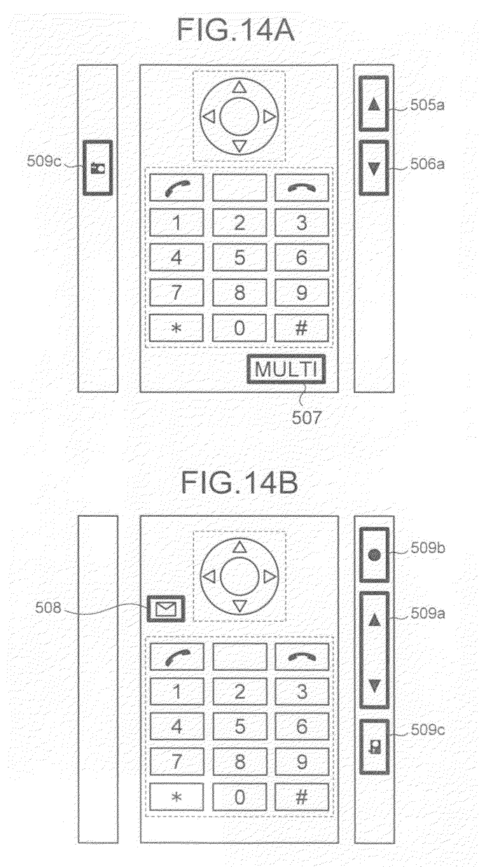

For this purpose, the server device 100 stores in advance an image of the operation keys including the non-common operation keys corresponding to each type of the portable terminal device (see FIGS. 14A and 14B). Upon receiving an access from the portable terminal device 500 via a public line, the server device 100 receives assignment of a type of the portable terminal device 500, transmits an image of operation keys corresponding to this type of the terminal device to the portable terminal device 500, and causes the portable terminal device 500 to download the image of the operation keys ((0) in FIG. 11).

The portable terminal device 500 establishes a communication connection with the in-vehicle device 300 ((1) in FIG. 11), and starts an application such as a navi-application, which is determined in advance to be linked between the portable terminal device 500 and the in-vehicle device 300, generates an application image, and transmits this application image ((2) in FIG. 11) and the downloaded image of the operation keys to the in-vehicle device 300 ((3) in FIG. 11).

On the other hand, the in-vehicle device 300 receives the application image and the images of the common operation keys and the non-common operation keys from the portable terminal device 500, superimposes these images, and displays a superimposed image in the touch panel ((4) in FIG. 11). When any one of these operation keys is pressed ((5) in FIG. 11), the in-vehicle device 300 transmits to the portable terminal device 500 coordinates of the touch position on the display, for example, where the pressing is detected ((6) in FIG. 11).

The portable terminal device 500 interprets as an operation command a command corresponding to the touch position sent from the in-vehicle device 300, based on a relationship between the coordinates and the command defined in advance ((7) in FIG. 11), and executes this operation command.

In this way, the common operation keys and the non-common operation keys of different types of the portable terminal device 500 are displayed in the touch panel of the in-vehicle device 300, and operation corresponding to these operation keys is converted into a command. Therefore, the non-common operation keys which vary depending on carriers, manufacturers, and manufacturing periods can be reproduced in the in-vehicle device 300.

Consequently, in the second embodiment, a command corresponding to the non-common operation keys can be received by remote control via the touch panel of the in-vehicle device 300, and remote control of the portable terminal device via the in-vehicle device can be improved.

In the second embodiment, because a command corresponding to the non-common operation key is remote-controlled within a vehicle as a mobile unit, an occupant, particularly a driver does not need to take out and directly operate the portable terminal device 500. Because remote control can be executed via a larger screen than that of the portable terminal device 500, even a driver who is restricted from performing operations other than driving can safely and easily use all functions of the portable terminal device.

Configurations of devices constituting the remote control system according to the second embodiment are explained next. A configuration of the in-vehicle device 300 is explained first, and a configuration of the portable terminal device 500 is then explained.

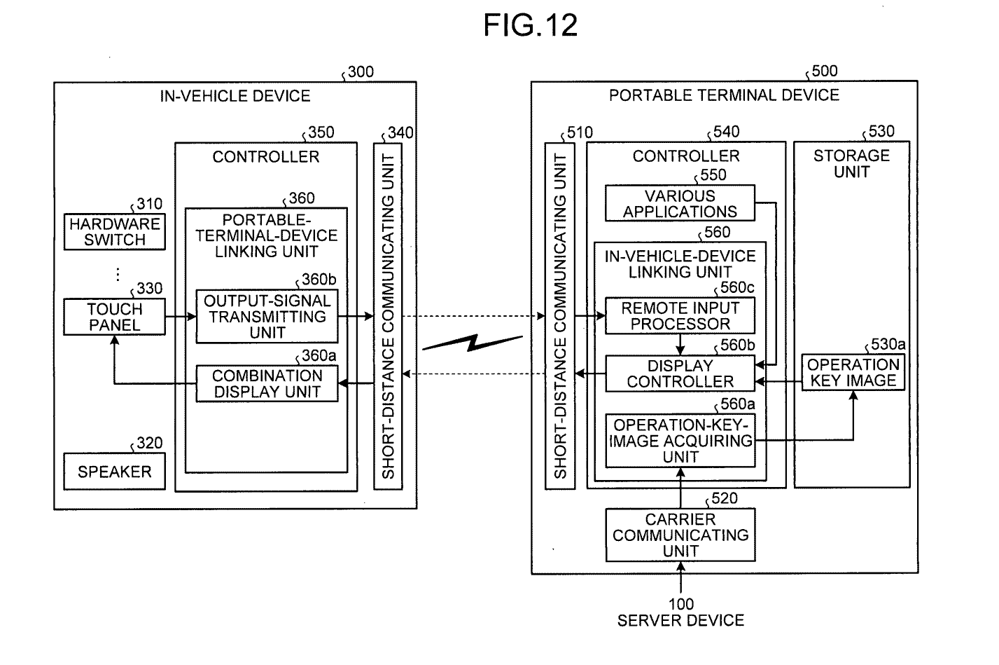

FIG. 12 is a functional block diagram of a configuration of various devices constituting the remote control system 2 according to the second embodiment. FIG. 12 depicts only constituent elements necessary to explain characteristics of the in-vehicle device 300 and the portable terminal device 500, and omits descriptions of general constituent elements.

As illustrated in FIG. 12, the in-vehicle device 300 includes a hardware switch 310, a speaker 320, a touch panel 330, a short-distance communicating unit 340, and a controller 350.

The hardware switch 310 is an input device similar to the hardware switch 12 described in the first embodiment. For example, a mechanical switch such as a push switch, a slide switch, and a rotary switch is the hardware switch 310. The speaker 320 is an audio device outputting an audio signal output from the controller 350. One or more speakers 320 can be provided for one vehicle.

The touch panel 330 is an input/output device similar to the touch panel display 11 described in the first embodiment, and can receive an operation input on a display device such as a liquid-crystal panel and a display panel. For example, the touch panel 330 can display an image specific to the in-vehicle device 300, an application image generated by various applications of the portable terminal device 500 (such as a navigation image and a moving image), and an operation key image of the common operation keys and the non-common operation keys. Further, the touch panel 330 can detect coordinates on the display pressed by an operator.

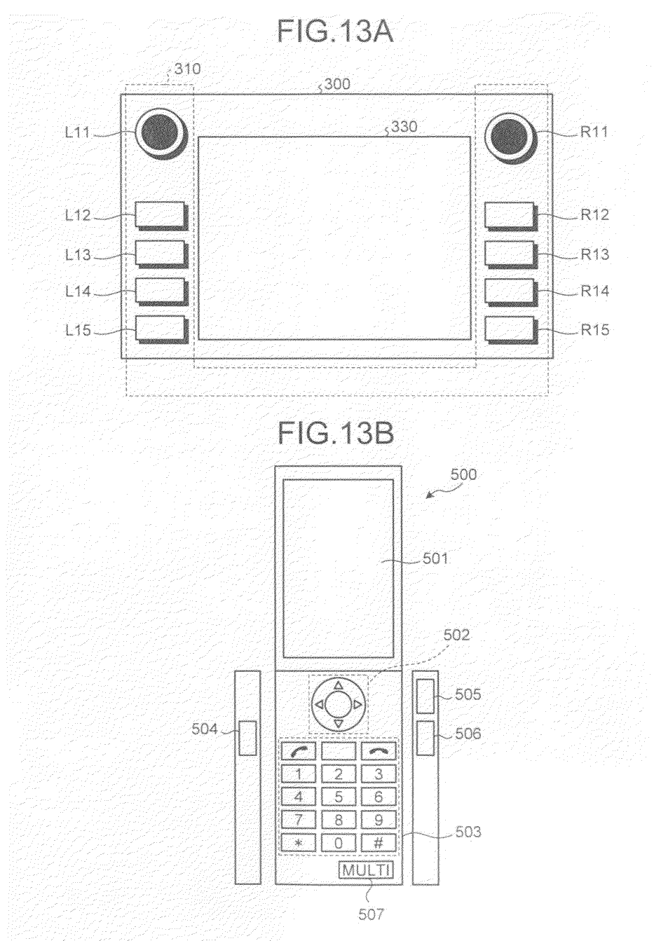

Operation switches provided in the in-vehicle device 300 and the portable terminal device 500 are explained with reference to FIGS. 13A and 13B. FIGS. 13A and 13B depict various operation switches of the in-vehicle device 300 and the portable terminal device 500. FIG. 13A depicts various operation switches of the in-vehicle device 300, and FIG. 13B depicts various operation switches of the portable terminal device 500.

As illustrated in FIG. 13A, the touch panel 330 is arranged in front of the in-vehicle device 300, and the hardware switch 310 is arranged around the touch panel 330.

The hardware switch 310 includes dials and buttons. In FIG. 13A, a dial L11, a button L12, a button L13, a button L14, and a button L15 are arranged at the left side, and a dial R11, a button R12, a button R13, a button R14, and a button R15 are arranged at the right side.

As illustrated in FIG. 13B, an arrow key 502 to instruct a shift in directions of up, down, right, and left, and a ten-key 503 are arranged on an operation surface of the portable terminal device 500. A side-surface key 504 is arranged on a left surface to the operation surface, and a side-surface key 505 and a side-surface key 506 are arranged on a right surface to the operation surface. A MULTI key 507 is arranged at a lower part of the operation surface.

While the portable terminal device 500 has a display 501, an output screen of an application is not displayed during linkage with the in-vehicle device 300, and the display is in a pause state, or a message such as “linking” is displayed to indicate that the portable terminal device 500 is linked with the in-vehicle device 300.

Usually, the layout and the type of the input keys included in the arrow key 502 and the ten-key 503, and whether the side-surface keys are present or not are different for each type of the portable terminal device 500. While there are “common operation keys” such as numeric keys from “0” to “9”, the “*” key, and a “#” key included in the ten-key 503, for which the layout and the types are common to all the portable terminal devices 500, there are “non-common operation keys” such as the side-surface key 506 and the MULTI key 507 that are not common to different types of the portable terminal devices 500.

Referring back to FIG. 12, explanations of the configuration of the in-vehicle device 300 are continued. The short-distance communicating unit 340 establishes a communication link with the portable terminal device 500 by using the short-distance wireless communication such as Bluetooth, and performs a communication process between the in-vehicle device 300 and the portable terminal device 500 by using the established communication link.

In the second embodiment, an example where communications are performed between the in-vehicle device 300 and the portable terminal device 500 by using Bluetooth is explained. However, other wireless communication standards such as Wi-Fi and ZigBee can be also used. Alternatively, wired communications can be also performed between the in-vehicle device 300 and the portable terminal device 500.

The controller 350 controls the entirety of the in-vehicle device 300, and has a portable-terminal-device linking unit 360. In practice, the controller 350 stores programs corresponding to a functional unit as described above into a read-only memory (ROM) or a nonvolatile memory (not shown). The controller 350 executes these programs by loading them into a central processing unit (CPU), and causes it to perform a process corresponding to the portable-terminal-device linking unit 360.

The portable-terminal-device linking unit 360 is a functional unit that performs various processes linked with the portable terminal device 500. Specifically, the portable-terminal-device linking unit 360 has a basic function of the in-vehicle device 300, that is, a function to cause display data and audio data generated by various applications 550 of the portable terminal device 500 to be output by at least one of the speaker 320 and the touch panel 330. Further, the portable-terminal-device linking unit 360 includes a combination display unit 360a and an output-signal transmitting unit 360b, as specific functional units of the second embodiment.

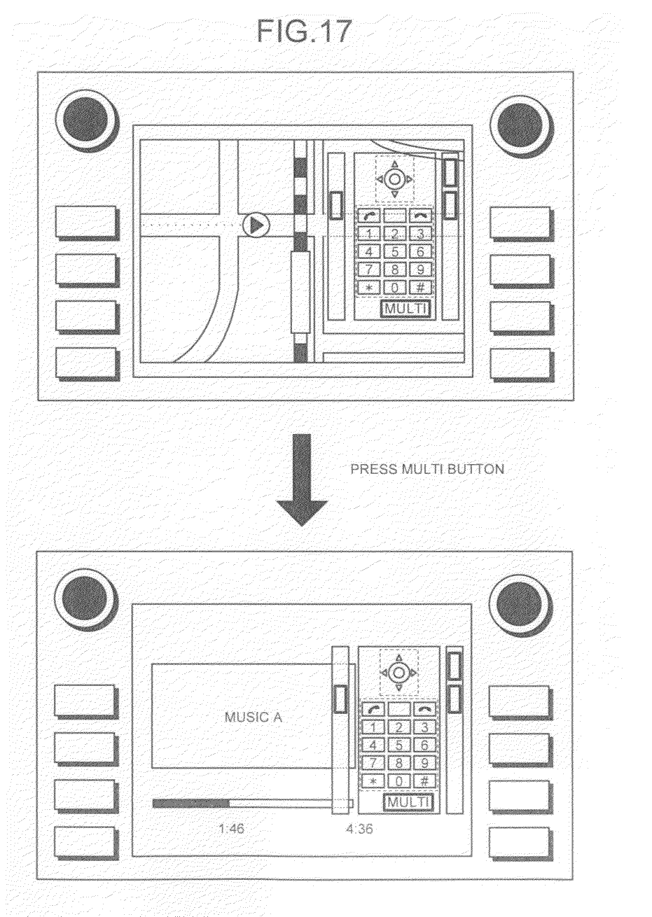

The combination display unit 360a is a processor that combines the application screen sent from the portable terminal device 500 via the short-distance communicating unit 340 with an operation key image, and outputs a combined screen to the touch panel 330. For example, to display in superimposition an operation key image on all or a part of an area of the application image, the application image is determined to be in a lower layer, and the operation key image is determined to be in an upper layer. The combination display unit 360a performs an imaging process of setting transparency of the operation key image covering all or a part of the area of the application image to a higher level than that of the application image, thereby displaying both images in superimposition (see FIG. 17).

Further, the combination display unit 360a can set a degree of dependence indicating how much of the contents provided by the application depend on the screen display, and can change a size of the operation key screen on the application screen according to the degree of dependence. For example, tuner software or audio software has a relationship according to which the sound is superior and the image is subordinate. For these software, the application screen does not need to have an excessively large size. Therefore, the operation key screen is set large. On the other hand, mail software or the like depends only on a screen display for information transmission. In this case, the operation key screen can be set small, or the screen is not displayed unless the touch panel 330 is touched.

By performing the superimposed display described above, visibility of the application image can be secured while increasing operability, in comparison with the direct operation of the portable terminal device 500. Alternatively, the operation key image can be displayed only when a predetermined operation is performed, for example, only when the touch panel 330 is touched.

The output-signal transmitting unit 360b is a processor transmitting an output signal to the portable terminal device 500 via the short-distance communicating unit 340, when the operation key on the touch panel 330 is operated. Specifically, when one of the common operation key or the non-common operation key on the operation key screen displayed by the combination display unit 360a is pressed, the output-signal transmitting unit 360b notifies pressed coordinates (touch position) on the display to the portable terminal device 500.

A configuration of the portable terminal device according to the second embodiment is explained next. As illustrated in FIG. 12, the portable terminal device 500 includes a short-distance communicating unit 510, a carrier communicating unit 520, a storage unit 530, and a controller 540.

The short-distance communicating unit 510 establishes a communication link with the in-vehicle device 300 by using the short-distance wireless communication such as Bluetooth, and performs a communication process between the portable terminal device 500 and the in-vehicle device 300 by using the established communication link, in a similar manner to the short-distance communicating unit 340 of the in-vehicle device 300.

The carrier communicating unit 520 is a processor performing electric wave communications with a target device via a base station of a telecommunication carrier or a telecommunication center. The carrier communicating unit 520 can also perform a website access cooperating with a website browser operating in the controller 540.

The storage unit 530 is a storage device such as a nonvolatile memory storing data and programs necessary for various processes performed by the controller 540. For example, the storage unit 530 stores the operation key image of the portable terminal device 500 as an operation key image 530a.

The operation key image 530a is downloaded by an operation-key-image acquiring unit 560a described later. Specifically, the operation-key-image acquiring unit 560a downloads an operation key image corresponding to the portable terminal device 500 among operation key images illustrated in FIGS. 14A and 14B. In these operation key images, the common operation keys such as the arrow key 502 and the ten-key 503 are common to carriers and manufacturers. The non-common operation keys depicted by thick frames in FIGS. 14A and 14B are different for each carrier and manufacturer in layout numbers, layout positions, or functions.

For example, in the operation key images in FIGS. 14A and 14B, layout of a camera starting button 509c incorporated in the portable terminal device 500 is different. While the MULTI key 507 is provided in the operation keys in FIG. 14A, the MULTI key is not provided in the operation keys in FIG. 14B. While a mail starting button 508 is provided in the operation keys in FIG. 14B, the mail starting button 508 is not provided in the operation keys in FIG. 14A. Positioning of the non-common operation keys is different between carriers and manufacturers in other various aspects (for example, layout of memo reproduction keys 505a and 506b, and a memo reproduction key 509a may be different, and a recording button 509b may be present or absent).

Therefore, in the second embodiment, the operation-key-image acquiring unit 560a described later downloads the operation key image corresponding to a type of the portable terminal device 500 from the server device 100.

The controller 540 controls the entirety of the portable terminal device 500, and includes the various applications 550 and an in-vehicle-device linking unit 560. In practice, the controller 540 stores programs corresponding to functional units like these in a ROM or a nonvolatile memory (not shown). The controller 540 causes processes to be performed corresponding to the various applications 550 and the in-vehicle-device linking unit 560.

The various applications 550 include navigation software, mail software, tuner software, and audio software. Specifically, when connection between the portable terminal device 500 and the in-vehicle device 300 is established and these devices are linked, the various applications 550 are loaded from the storage unit 530 in response to a request from the in-vehicle-device linking unit 560 described later, and are started. The various applications 550 perform processes corresponding to a remote-controlled command via the touch panel 330 of the in-vehicle device 300.

The in-vehicle-device linking unit 560 is a functional unit that performs various processes linked with the in-vehicle device 300. Specifically, the in-vehicle-device linking unit 560 has a basic function concerning link with the in-vehicle device 300, interprets a received command from a touch position sent from the in-vehicle device 300, and starts the various applications 550 by loading these applications from the storage unit 530. At the same time, the in-vehicle-device linking unit 560 includes the operation-key-image acquiring unit 560a, a display controller 560b, and a remote input processor 560c, as specific functions of the second embodiment.

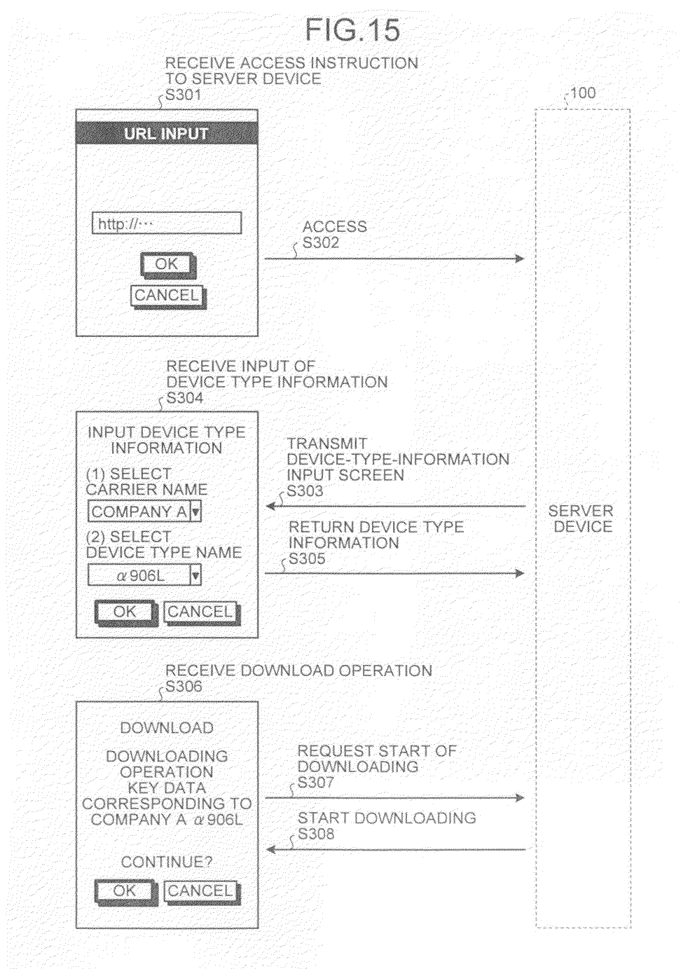

The operation-key-image acquiring unit 560a is a processor acquiring an operation key image from an external device or an external storage medium. A detail is explained with reference to FIG. 15. In brief, the operation-key-image acquiring unit 560a accesses an website of a uniform resource locator (URL) acquired by the server device 100, assigns a type of the portable terminal device 500, acquires the operation key image corresponding to this type, for example, the image in FIG. 14A, and stores the image in the storage unit 530.

The display controller 560b is a processor displaying the common operation keys and the non-common operation keys in the touch panel 330 of the in-vehicle device 300, by using the operation key image 530a stored in the storage unit 530. Specifically, when a communication link is established with the in-vehicle device 300, the display controller 560b starts an application such as a navi-application linked in advance with the in-vehicle device 300, causes the started navi-application to generate an application image, transmits the application image to the in-vehicle device 300, and transmits the operation key image 530a stored in the storage unit 530 to the in-vehicle device 300. In the second embodiment, while the in-vehicle device 300 performs a superimposed display of the application image and the operation key image, the display controller 560b can also perform the imaging process described above and transmit display data to the in-vehicle device 300.

The remote input processor 560c interprets a command based on a touch position sent from the in-vehicle device 300 via the short-distance communicating unit 510, and executes the command. Specifically, based on a relationship between coordinates and a command defined in advance, the remote input processor 560c interprets a command from a touch position, and allocates the command (output signal or output signal sequence corresponding to the operation key) to each application corresponding to the command as an input signal to the application. With this arrangement, each application can operate in a similar manner to when the input key of the portable terminal device 500 is directly operated.

A process flow of the remote control system according to the second embodiment is explained next. An operation-key-image acquiring process performed before displaying the operation key in the touch panel 330 of the in-vehicle device 300 is explained first, and a remote control process is then explained.

The operation-key-image acquiring process according to the second embodiment is explained first. This process is performed when a power source of the portable terminal device 500 is in an ON state and the portable terminal device 500 is present within a range of communication with a base station.

FIG. 15 depicts an operation sequence of the operation-key-image acquiring process according to the second embodiment. As illustrated in FIG. 15, the operation-key-image acquiring unit 560a receives input of a URL of the server device 100 provided by a carrier or manufacturer (Step S301), and accesses the server device 100 by using a web browser (Step S302).

The server device 100 receives access from the portable terminal device 500, and transmits a device-type-information input screen to the portable terminal device 500 to specify a device type of the operation key image to be downloaded (Step S303).

The operation-key-image acquiring unit 560a receives input of device-type information of the portable terminal device 500 according to a format defined in the device-type-information input screen (Step S304), and returns the received device-type information to the server device 100 (Step S305). In the example of FIG. 15, a device-type name is selected after narrowing a range of device types by selecting a carrier name. Alternatively, a format may be prepared so that the user can freely and directly input the type name of the device.

The operation-key-image acquiring unit 560a then receives an operation of downloading the operation key image on a download confirmation screen sent from the server device 100 (Step S306). The operation-key-image acquiring unit 560a requests the server device 100 to download the operation key image (Step S307). The server device 100 starts downloading (Step S308). The operation-key-image acquiring unit 560a stores a downloaded operation-key image in the storage unit 530, and ends the process.

In this manner, the operation key image which is different for each device type of the portable terminal device 500 is acquired. By using the operation key image, an operation key screen including the non-common operation keys can be displayed in the touch panel 330 of the in-vehicle device 300.

In the second embodiment, while only the operation key image is downloaded from the server device 100, downloading can be also performed by using a remote control operation application having functions of the display controller 560b and the remote input processor 560c.

Because the remote control application is not necessarily essential to function as a single application in the portable terminal device 500, this application is not always installed in the portable terminal device 500. However, when the operation key image and the remote control application are downloaded together, an in-vehicle service of remote-controlling the portable terminal device 500 can be received by taking this action only once.

In the second embodiment, the operation key image is downloaded from the server device 100 operated by a carrier or manufacturer. Alternatively, the operation key image can be acquired from a flash memory for a portable terminal device such as a secure digital (SD) memory card or other portable terminal devices.

The remote control process according to the second embodiment is explained next. The remote control process is a process performed when both the in-vehicle device 300 and the portable terminal device 500 are present within a communication range.

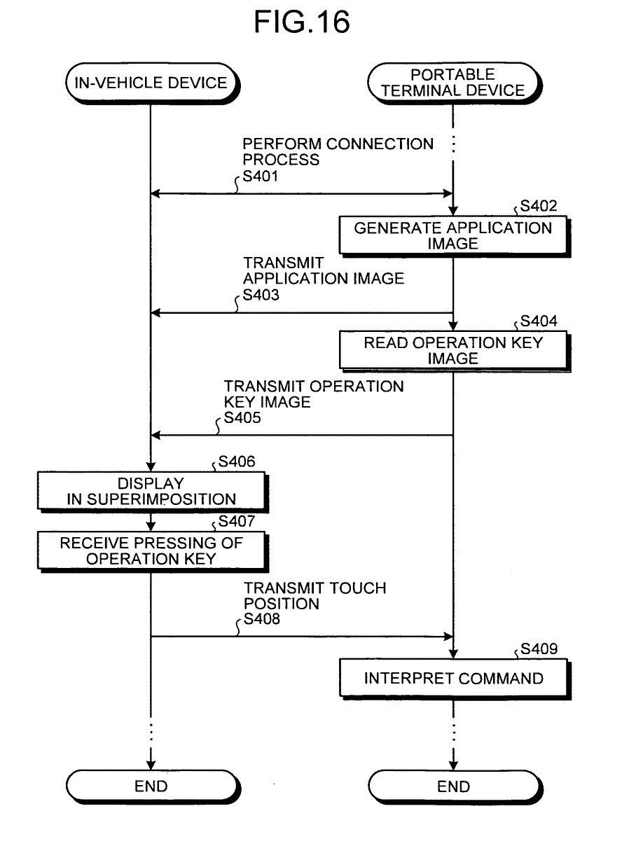

FIG. 16 depicts a control sequence between the in-vehicle device and the portable terminal device according to the second embodiment. As illustrated in FIG. 16, the in-vehicle device 300 and the portable terminal device 500 are connected with each other (Step S401), whereby a communication link between the in-vehicle device 300 and the portable terminal device 500 is established. Upon establishing the communication link, both devices can actively make a connection request, or one device can make a connection request to the other device.

When a communication link is established in this way, the display controller 560b of the portable terminal device 500 starts an application such as a navi-application, which is determined to be linked with the in-vehicle device 300 in advance, causes the started navi-application to generate an application image, transmits the application image to the in-vehicle device 300 (Steps S402 and S403), and transmits the operation key image 530a stored in the storage unit 530 to the in-vehicle device 300 (Steps S404 and S405).

Meanwhile, the combination display unit 360a displays the application image sent from the portable terminal device 500 and the operation key image in superimposition on the touch panel 330 (Step S406). When the common operation key or the non-common operation key on the operation key screen are pressed (Step S407), the output-signal transmitting unit 360b transmits pressed coordinates (touch position) on the display to the portable terminal device 500 (Step S408).

The remote input processor 560c of the portable terminal device 500 interprets a command corresponding to the touch position as the operation command, based on a relationship between coordinates and the command defined in advance (Step S409). The remote input processor 560c allocates the interpreted command (output signal or output signal sequence corresponding to the operation key) to each application corresponding to the command as an input signal to the application, and ends the process.

In this way, by transmitting the operation key image to the in-vehicle device 300 when a communication link is established for the first time or at each time when a communication link is established, the operation key image does not need to be transmitted until the operation key image is erased at the in-vehicle device 300 side.

For example, when a device type of the portable terminal device 500 is the operation key image depicted in FIG. 14A, and when the MULTI key 507 displayed as the operation key screen in the touch panel 330 of the in-vehicle device 300 is pressed, the portable terminal device 500 changes the application image to be actively displayed on the screen to one of plural applications operating in the background.

As one utilization example of the MULTI key 507, as illustrated in FIG. 17, an image of a navi-application is displayed until the MULTI key 507 is pressed. After the MULTI key 507 is pressed, an image of an audio application can be displayed on the touch panel 330.

By achieving remote control of the non-common operation keys such as the MULTI key 507, the application displayed on the touch panel 330 can be changed over by smaller steps of operation procedure than steps required in cumbersome operation procedure including ending the navi-application and starting the audio application using only the common operation keys. Thus, remote control operability of the portable terminal device 500 can be improved.

As described above, in the second embodiment, operation key information including information of the non-common operation keys corresponding to a device type of the portable terminal device 500 and not common to other types of devices is obtained. The operation key is displayed in the touch panel of the in-vehicle device 300 based on the acquired operation key information. The operation to the operation key displayed in the touch panel is converted into a command corresponding to the operation. Therefore, the non-operation keys which are different for carriers, manufacturers, and manufacturing periods, can be reproduced in the in-vehicle device 300. A command corresponding to the non-common operation keys can be received by remote control via the touch panel of the in-vehicle device 300. As a result, remote control of the portable terminal device via the in-vehicle device can be improved.

In the second embodiment, by acquiring an image of the operation key corresponding to a device type of the portable terminal device 500, the image of the operation key is displayed in the touch panel 330 of the in-vehicle device 300. Therefore, a process of drawing a screen part such as a button icon constituting the operation key screen is not necessary, and a linked application of the in-vehicle device 300 can be simplified. Further, by storing the operation key image on transmitting the operation key image to the in-vehicle device 300, the number of transmissions/receptions of the operation key image, which has a large data size, can be reduced.

In the second embodiment, the image of the operation key is transmitted to the in-vehicle device 300 when the operation key is displayed in the touch panel 330 of the in-vehicle device 300. However, it is not always necessary to transmit the image of the operation key. In a third embodiment of the present invention, displaying an operation key in the touch panel 330 by using other pieces of information is explained.

That is, a remote control system 3 according to the third embodiment causes a portable terminal device 900 to generate a drawing command as an instruction to draw an operation key to be displayed in the touch panel 330, by using information of the non-common operation keys acquired from the server device 100. The remote control system 3 causes an in-vehicle device 700 to draw the operation key to be displayed in the touch panel 330 according to the drawing command generated by the portable terminal device 900.

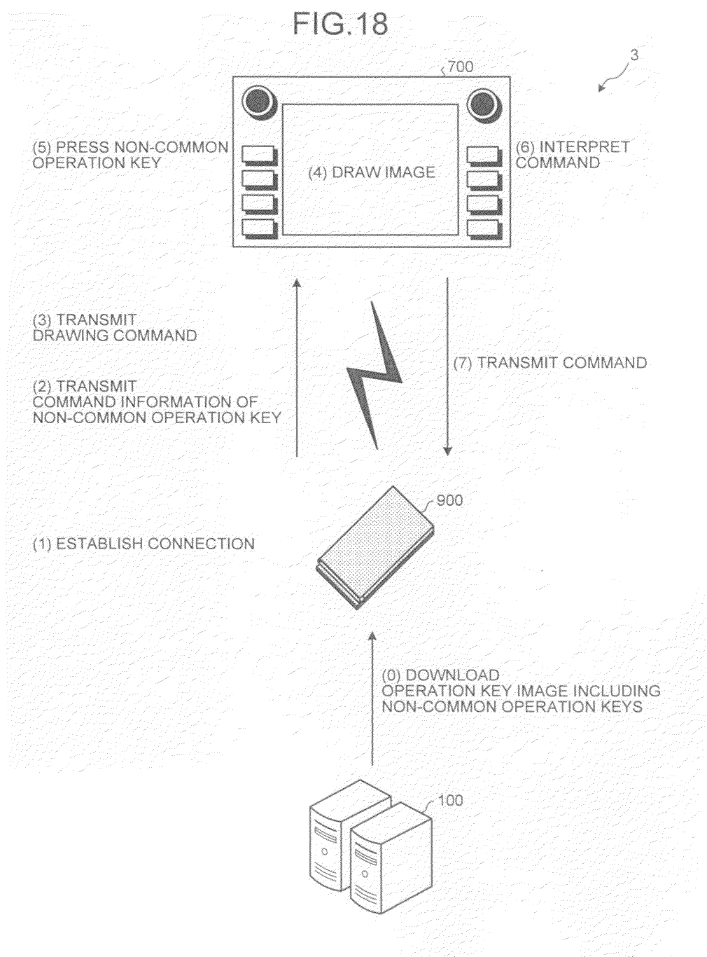

This is explained with reference to FIG. 18. The server device 100 has stored therein in advance non-common operation-key information for each device type of the portable terminal device. The non-common operation-key information is, for example, contents of a command and an image of the non-common operation key. Upon receiving access from the portable terminal device 900 via a public line, the server device 100 receives assignment of a device type of the portable terminal device 900, transmits the non-common operation-key information corresponding to the device type to the portable terminal device 900, and causes the portable terminal device 900 to download an image of the operation keys ((0) in FIG. 18).

Subsequently, the portable terminal device 900 establishes a communication connection with the in-vehicle device 700 ((1) in FIG. 18), transmits downloaded non-common operation-key information to the in-vehicle device 700 ((2) in FIG. 18), generates a range assignment of drawing coordinates, for example, and transmits a drawing command to the in-vehicle device 700 ((3) in FIG. 18).

On the other hand, the in-vehicle device 700 draws the non-common operation keys according to the drawing command sent from the portable terminal device 900 ((4) in FIG. 18). When receiving a press operation at coordinates where the non-common operation key is present, for example, ((5) in FIG. 18), the in-vehicle device 700 interprets the press operation as an instruction to execute a command corresponding to the non-common operation key ((6) in FIG. 18), and instructs the portable terminal device 900 to execute the interpreted command, thereby executing the command ((7) in FIG. 18).

As explained above, in the third embodiment, instead of an operation key image including the non-common operation keys, a drawing command is transmitted to the in-vehicle device 700. Therefore, the amount of data transmitted between the in-vehicle device 700 and the portable terminal device 900 can be reduced, whereby a quick response to the operation from an occupant is allowed.

In the third embodiment, among operation keys provided in the portable terminal device 900, only the non-common operation keys concerning the application operation are drawn. Therefore, the degree that the application screen is occupied by the operation key screen can be reduced, and visibility of the application image can be increased.

Furthermore, in the third embodiment, because the command content of the non-common operation keys is transmitted in advance before the non-common operation keys are displayed in the touch panel 330 of the in-vehicle device 700, the in-vehicle device 700 can interpret the command based on the coordinates at which the operation is received.

A configuration of various devices constituting the remote control system according to the third embodiment is explained next. An explanation is given below while comparing the remote control system according to the third embodiment with the remote control system according to the second embodiment. Constituent elements having similar functions to those in the second embodiment are denoted by like reference numerals, and explanations thereof will be omitted.

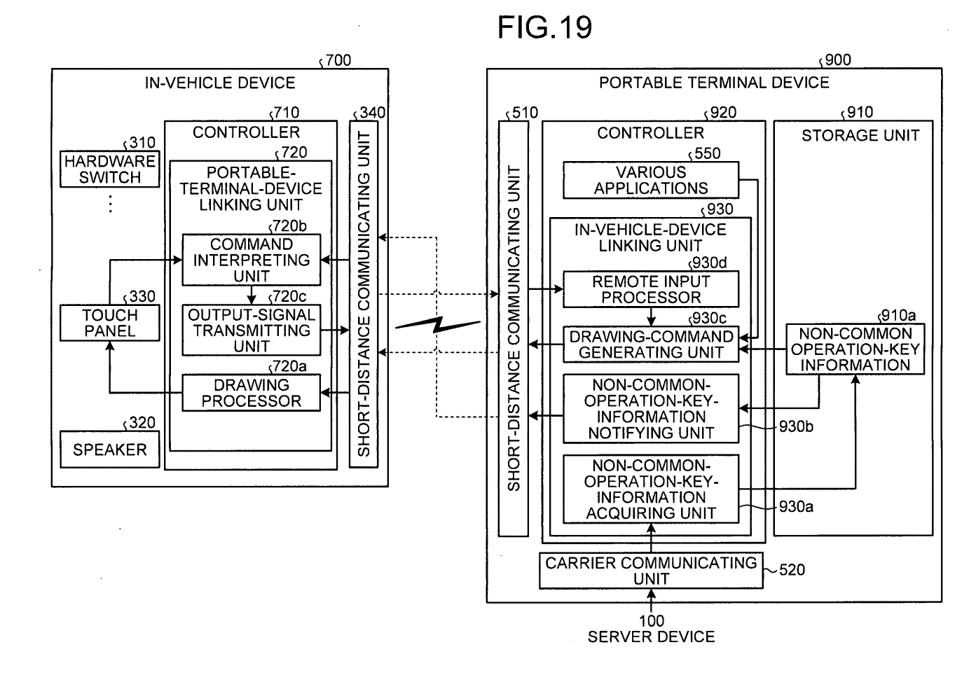

FIG. 19 is a functional block diagram of a configuration of various devices constituting the remote control system according to the third embodiment. As illustrated in FIG. 19, the in-vehicle device 700 is different from the in-vehicle device 300 illustrated in FIG. 12, in that the in-vehicle device 700 has a drawing processor 720a, a command interpreting unit 720b, and an output-signal transmitting unit 720c in a portable-terminal-device linking unit 720 of a controller 710, instead of the combination display unit 360a and the output-signal transmitting unit 360b in the portable-terminal-device linking unit 360 of the controller 350, and that a part of the processing content of the output-signal transmitting unit 720c is different from the output-signal transmitting unit 360b.

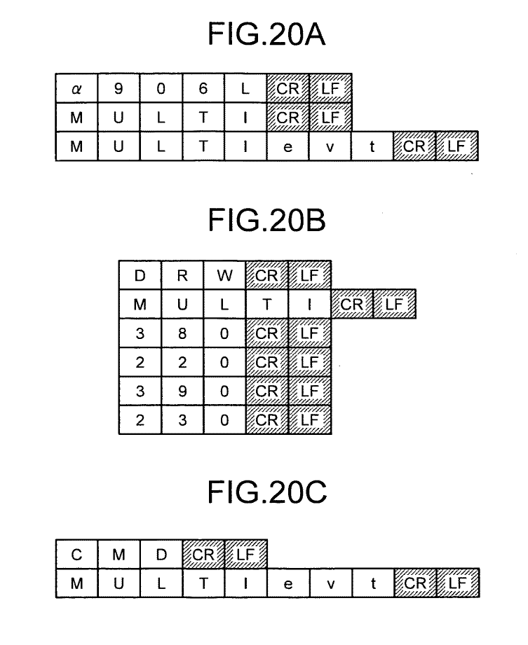

The drawing processor 720a draws the operation keys displayed in the touch panel 330 according to a drawing command sent from the portable terminal device 900. Specifically, by using the non-common operation-key information such as an image of the non-common operation keys received in advance from a non-common-operation-key-information notifying unit 930b described later, the drawing processor 720a draws the non-common operation keys to be displayed in the touch panel 330 according to a drawing command generated by a drawing-command generating unit 930c described later. The drawing command generated is, for example, an instruction (see FIG. 20B) assigning a coordinate range to draw the non-common operation keys.

The command interpreting unit 720b is a processor interpreting a command corresponding to the operation displayed in the touch panel 330. Specifically, when a touch position at which the press operation in the touch panel 330 is received corresponds to a coordinate range in which the non-common operation keys are drawn, for example, a range from (380, 220) to (390, 230) illustrated in FIG. 20B, the command interpreting unit 720b interprets the press operation as an execution instruction of a command MULTI (see FIG. 20A) of the non-common operation key corresponding to the coordinate range, among commands of the non-common operation keys. The commands of the non-common operation keys are sent from the non-common-operation-key-information notifying unit 930b described later in advance and held in a storage unit or the like. The command interpreting unit 720b transmits an execution instruction (see FIG. 20C) of the command of the non-common operation key to the portable terminal device 900 via the output-signal transmitting unit 720c.

The portable terminal device 900 is different from the portable terminal device 500 illustrated in FIG. 12, in that the portable terminal device 900 has non-common operation-key information 910a in a storage unit 910, that the portable terminal device 900 has a non-common-operation-key-information acquiring unit 930a instead of the operation-key-image acquiring unit 560a, has the non-common-operation-key-information notifying unit 930b and the drawing-command generating unit 930c instead of the display controller 560b, and that a part of the processing content of a remote input processor 930d is different from the remote input processor 560c. The non-common-operation-key-information acquiring unit 930a, the non-common-operation-key-information notifying unit 930b, the drawing-command generating unit 930c, and the remote input processor 930 are provided in an in-vehicle-device linking unit 930 of a controller 920.

The non-common-operation-key-information acquiring unit 930a is different from the operation-key-image acquiring unit 560a depicted in FIG. 12 in that the non-common-operation-key-information acquiring unit 930a is configured to acquire the non-common operation-key information including the content of an image and a command of the non-common operation keys while the operation-key-image acquiring unit 560a acquires the operation key image from the server device 100. An acquiring process is approximately the same as that of the operation sequence depicted in FIG. 15, and therefore explanations thereof will be omitted.

The non-common-operation-key-information notifying unit 930b is a processor notifying to the in-vehicle device 700 the non-common operation-key information 910a downloaded from the server device 100 and stored in the storage unit 910.

The drawing-command generating unit 930c is a processor generating a drawing command of the non-common operation keys. Specifically, the drawing-command generating unit 930c generates a drawing command assigning a coordinate range to draw the non-common operation key on the touch panel 330 of the in-vehicle device 700, and transmits the generated drawing command to the in-vehicle device 700.

The remote input processor 930d is different from the remote input processor 560c illustrated in FIG. 12 in that while the remote input processor 560c interprets a command by receiving a touch position of the touch panel 330, the remote input processor 930d receives a command of the non-common operation keys according to a change of the configuration interpreted at the in-vehicle device 700 side.

A remote control process according to the third embodiment is explained next. The remote control process is performed when both the in-vehicle device 700 and the portable terminal device 900 are present within a predetermined communication range.

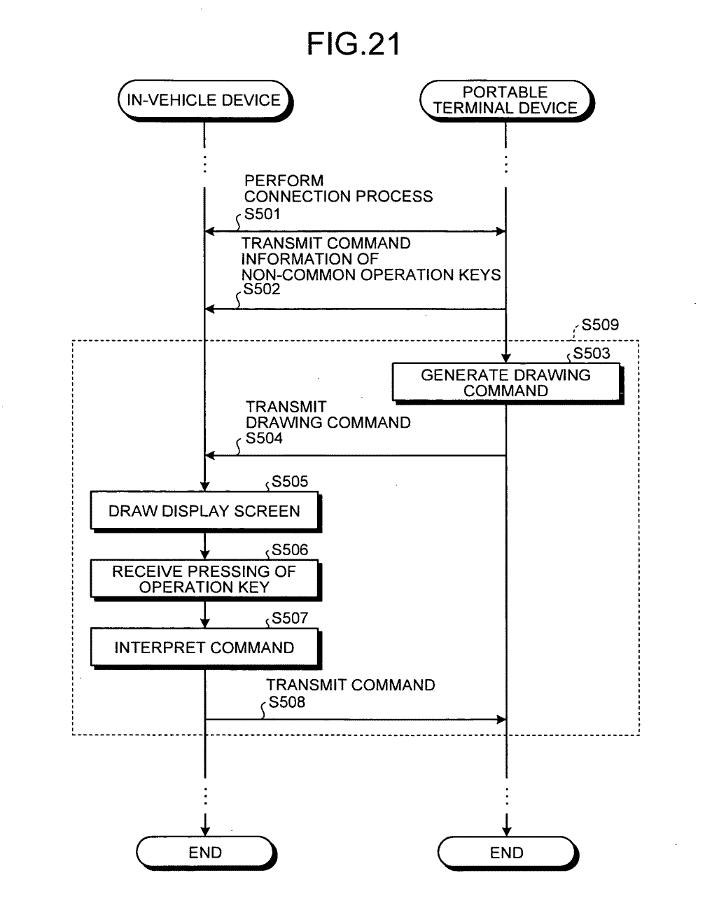

FIG. 21 depicts a control sequence between the in-vehicle device and the portable terminal device according to the third embodiment. As illustrated in FIG. 21, the in-vehicle device 700 and the portable terminal device 900 perform a connection process (Step S501), thereby establishing a communication link between the in-vehicle device 700 and the portable terminal device 900.

When a communication link is established in this way, the non-common-operation-key-information notifying unit 930b of the portable terminal device 900 notifies to the in-vehicle device 700 the non-common operation-key information 910a downloaded from the server device 100 and stored in the storage unit 910 (Step S502).

The drawing-command generating unit 930c of the portable terminal device 900 generates a drawing command assigning a coordinate range to draw the non-common operation keys on the touch panel 330 of the in-vehicle device 700 (Step S503), and transmits the generated drawing command to the in-vehicle device 700 (Step S504).

On the other hand, the drawing processor 720a of the in-vehicle device 700 draws the non-common operation keys to be displayed in the touch panel 330 according to an instruction (see FIG. 20B) assigning a coordinate range to draw the non-common operation keys, by using the non-common operation-key information such as an image of the non-common operation keys received in advance from the non-common-operation-key-information notifying unit 930b (Step S505).

Upon receiving a press operation in the coordinates where the non-common operation key is present in the touch panel 330 (Step S506), the command interpreting unit 720b interprets the press operation as an execution instruction of the command MULTI (see FIG. 20A) of the non-common operation key corresponding to the coordinate range in which the press operation is received (Step S507), and transmits an execution instruction (see FIG. 20C) of the command of the non-common operation key to the portable terminal device 900 via the output-signal transmitting unit 720c (Step S508).

The remote input processor 930d allocates the command notified to the portable terminal device 900 to the various applications 550, and executes the command.

A drawing position of the non-common operation keys can be changed by repeating the process of Step S509 including a series of processes from Step S503 to S508 following shifting of the application image.

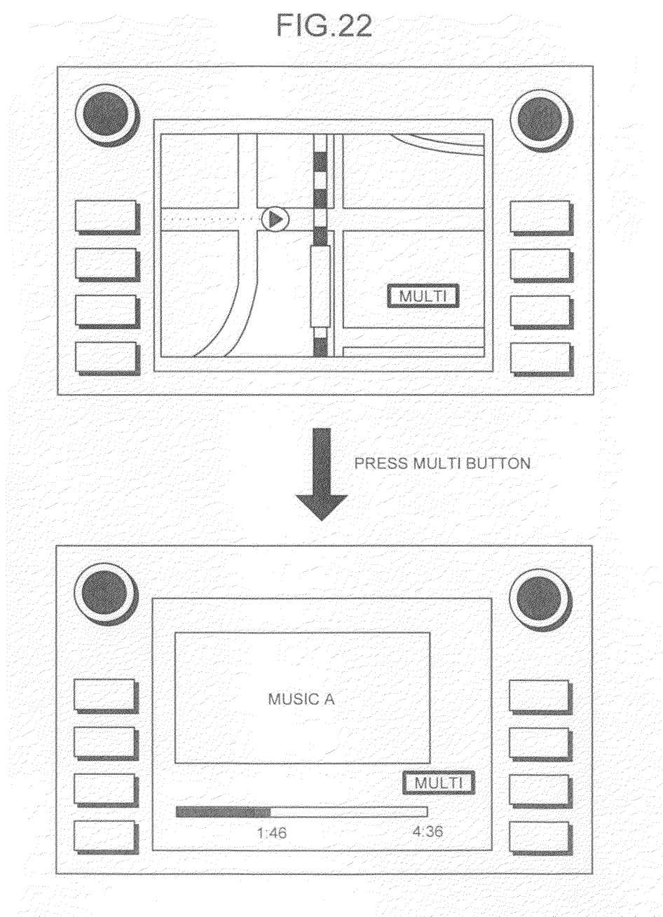

For example, as illustrated in FIG. 22, if the MULTI key 507 drawn on the screen of the navi-application is pressed while a screen of the navi-application is displayed in the touch panel 330, the images can be changed over so that the image of the navi-application is displayed before the pressing operation of the MULTI key 507 and the image of an audio application is displayed on the touch panel 330 after the pressing operation of the MULTI key 507 in a similar manner to the second embodiment.

As described above, in the third embodiment, the portable terminal device 900 generates a drawing command as an instruction to draw the operation keys to be displayed in the touch panel 330, by using the information of the non-common operation keys acquired from the server device 100. The in-vehicle device 700 draws the operation keys to be displayed in the touch panel 330 according to the drawing command generated by the portable terminal device 900. Therefore, the amount of data transmitted between the in-vehicle device 700 and the portable terminal device 900 can be reduced, whereby a quick response to the operation from an occupant is allowed.

In the third embodiment, while only the non-common operation keys concerning the application operation are drawn, the present invention is not limited to this embodiment. The entire operation keys including the common operation keys can be drawn, in a similar manner to that of the second embodiment.

In the present invention, in addition to the content of the second and third embodiments, a running speed can be acquired from an electronic control unit (ECU) mounted on a vehicle, and a display control of the operation keys or the interpretation of the command in the touch panel can be restricted according to the acquired running speed of the vehicle.

For example, while a vehicle is parked, the operation keys including the non-common operation keys can be displayed to remote-control the portable terminal device in the touch panel 330, and while the vehicle is running, display of all or a part of the non-common operation keys on the touch panel 330 can be prohibited to prevent interruption of driving. With this arrangement, while keeping safe driving, the non-common operation keys can be remote-controlled when the vehicle is parked. When the vehicle is running at a very low speed, only a part of the common operation keys can be displayed. In this case, it is preferable to permit only operation keys of which operation procedure to a target command has a smaller number of steps than a predetermined number of steps.

In the first to third embodiments, one in-vehicle device is provided for one portable terminal device. However, one-to-one relation is not always necessary. The present invention is similarly applicable to a system including one in-vehicle device and N potable terminal devices.

As described above, the in-vehicle device, the remote control system, and the remote control method according to the present invention are useful for remote-controlling a portable terminal device using an in-vehicle device, and particularly useful for improving operability of remote-control of a portable terminal device.

The above and other objects, features, advantages and technical and industrial significance of this invention will be better understood by reading the following detailed description of presently preferred embodiments of the invention, when considered in connection with the accompanying drawings.

What is claimed is:

1. An in-vehicle device that remote-controls a portable terminal device, comprising:
a layout-information acquiring unit that acquires layout information of input keys of the portable terminal device;
an input/output unit that includes a touch panel display displaying an image and receiving a user input;
a relating unit that relates each input key included in the layout information to a predetermined area on the touch panel display;
a combination display unit that displays in the touch panel display a layout screen of the each input key related by the relating unit to a predetermined area on the touch panel display;
a converting unit that converts, based on the layout information, an input to the touch panel display into an output signal or a combination of the output signals corresponding to a pressing operation of the input key; and
a transmitting unit that transmits the output signal obtained as a result of conversion by the converting unit to the portable terminal device.

2. The in-vehicle device according to claim 1, wherein the combination display unit superimposes a display screen generated by the portable terminal device with the layout screen when the touch panel display receives a predetermined input.

3. The in-vehicle device according to claim 1, wherein
the input/output unit further includes a hardware switch that receives a user operation, and
the relating unit relates each input key included in the layout information to the hardware switch.

4. The in-vehicle device according to claim 3, wherein the relating unit displays in the touch panel display a relation screen that indicates a relationship between the input key and the hardware switch, and when the touch panel display receives an input for changing the relationship, the relating unit uses a changed relationship as a new relationship.

5. The in-vehicle device according to claim 1, wherein the converting unit converts one input to the touch panel display into an output signal sequence corresponding to a plurality of the input keys.

6. The in-vehicle device according to claim 5, wherein when the input keys are an upward-shift instruction key, a downward-shift instruction key, a leftward-shift instruction key, and a rightward-shift instruction key, the converting unit converts the one input to the touch panel display into the output signal sequence corresponding to any one of combinations of the upward-shift instruction key or the downward-shift instruction key and the leftward-shift instruction key or the rightward-shift instruction key.

7. The in-vehicle device according to claim 6, wherein the converting unit adjusts an order of the output signals in the output signal sequence to minimize number of consecutive output signals corresponding to the same input key in the output signal sequence.

8. A remote control system for an in-vehicle device that remote-controls a portable terminal device, wherein
the in-vehicle device includes:
a layout-information acquiring unit that acquires layout information of input keys of the portable terminal device;
an input/output unit that includes a touch panel display displaying an image and receiving a user input;
a relating unit that relates each input key included in the layout information to a predetermined area on the touch panel display;
a combination display unit that displays in the touch panel display a layout screen of the each input key related by the relating unit to a predetermined area on the touch panel display;
a converting unit that converts, based on the layout information, an input to the touch panel display into an output signal or a combination of the output signals corresponding to a pressing operation of the input key; and
a transmitting unit that transmits the output signal obtained as a result of conversion by the converting unit to the portable terminal device, and wherein
the portable terminal device includes:
a notifying unit that notifies the layout information to the in-vehicle device; and
a remote input unit that receives the output signal sent from the in-vehicle device by regarding the output signal as an output signal corresponding to a pressing operation of the input key of the portable terminal device.

9. A remote control system causing an operation key for remote controlling a portable terminal device to be displayed in a display/input unit of an in-vehicle device linked with the portable terminal device, the system comprising:
an acquiring unit that acquires operation key information including information of non-common operation keys which are operation keys corresponding to a device type of the portable terminal device and not common to other device types;
a display controller causing an operation key to be displayed in the display/input unit of the in-vehicle device based on the operation key information acquired by the acquiring unit; and
an operation converting unit that converts an operation to an operation key displayed in the display/input unit by the display controller into a command corresponding to the operation.

10. The remote control system according to claim 9, wherein
the acquiring unit acquires an image of an operation key corresponding to a device type of the portable terminal device, and
the display controller causes an image of the operation key acquired by the acquiring unit to be displayed in the display/input unit.

11. The remote control system according to claim 9, wherein
the display controller further includes:
a drawing-command generating unit that generates a drawing command as an instruction to draw an operation key to be displayed in the display/input unit by using operation key information acquired by the acquiring unit; and
a drawing unit that draws an operation key to be displayed in the display/input unit according to a drawing command generated by the drawing-command generating unit, and wherein
the drawing-command generating unit is present in the portable terminal device, and the drawing unit is present in the in-vehicle device.

12. The remote control system according to claim 9, wherein the display controller further includes a combination display unit that superimposes an operation key screen generated from operation key information acquired by the acquiring unit with a display screen of information other than an operation key generated by the portable terminal device, and causes a superimposed screen to be displayed in the display/input unit.

13. The remote control system according to claim 9, wherein the display controller causes the non-common operation keys among the operation keys to be displayed in the display/input unit.

14. The remote control system according to claim 9, wherein the acquiring unit acquires an application to achieve functions of the display controller and the operation converting unit, together with the operation key information.

15. The remote control system according to claim 9, further comprising:
a running-speed acquiring unit that acquires a running speed of a vehicle; and
a process limiting unit that limits at least one of a display control of an operation key by the display controller and a command conversion by the operation converting unit, according to a running speed of a vehicle acquired by the running-speed acquiring unit.

16. A remote control method of a portable terminal device to be applied to a remote control system causing an operation key for remote-controlling the portable terminal device to be displayed in a display/input unit of an in-vehicle device linked with the portable terminal device, the remote control method comprising:
acquiring operation key information including information of non-common operation keys which are operation keys corresponding to a device type of the portable terminal device and not common to other device types;
causing an operation key to be displayed in the display/input unit of the in-vehicle device based on the operation key information acquired in the acquiring; and
converting an operation to an operation key displayed in the display/input unit into a command corresponding to the operation.
